(19) United States
(12) Patent Application Publication
(10) Pub. No.: US 2019/0356564 A1
(43) Pub. Date: Nov. 21, 2019

(54) MODE DETERMINING APPARATUS, METHOD, NETWORK SYSTEM, AND PROGRAM

(71) Applicant: NEC CORPORATION, Tokyo (JP)

(72) Inventors: Hiroya KANEKO, Tokyo (JP); Takanori IWAI, Tokyo (JP); Nobuhike ITOH, Tokyo (JP)

(73) Assignee: NEC CORPORATION, Tokyo (JP)

(21) Appl. No.: 16/477,027

(22) PCT Filed: Jan. 9, 2018
(86) PCT No.: PCT/JP2018/000184

§ 371 Date: Jul. 10, 2019

(30) Foreign Application Priority Data
Oct. 1, 2017 (JP) 2017-002158

(51) Int. Cl. H04L 12/26; H04L 29/06

(52) U.S. Cl. CPC H04L 43/04; H04L 43/028; G06N 20/00; H04L 69/163; H04L 69/22

(57) ABSTRACT

There are provided a filter part that receives traffic data for learning and learns timing at which mode switching in the traffic data occurs, using training data, a mode learning part that generates a mode learning model for mode determination, based on the traffic data for learning and the training data that correspond to the timing of mode switching; and a mode of traffic data is determined using the mode learning model.

### REFERENCE TO RELATED APPLICATION

This application is a National Stage of International Application No. PCT/JP2018/000184, filed on Jan. 9, 2018, which claims the benefit of the priority of Japanese patent application No. 2017-002158 filed on Jan. 10, 2017, the disclosure of which is incorporated herein in its entirety by reference thereto.

### FIELD

The present invention relates to a network system, mode determining apparatus, method, and non-transitory medium.

### BACKGROUND

In a system via a network (networked system), an end-to-end response time has a great influence on quality of experience (QoE: also known as “user experience quality”) of an application. For instance, bi-directional communication is performed in an interactive-type application such as an online game, in which a server, on reception of an operation input from a user terminal, forwards, to the terminal, screen information to be displayed on the terminal. For this reason, such factors as response time, delay, and jitter may affect user experience (UX). On the other hand, bandwidth becomes an issue in a batch type application in which communication from a server to a terminal is performed. It is noted that a quality of the user experience corresponds to QoE.

It is known that conditions to meet QoS (Quality of Service) (e.g., bandwidth, transmission delay, etc.) or QoE requirements (e.g., response time), and traffic patterns (data volume, cycle) are different for each mode of an application. In order to ensure fine-grained QoS and QoE for each mode of an application, the mode of the application needs to be estimated in some way.

On the other hand, it may be unrealistic to modify all applicable existing applications so that each application notifies its mode. Therefore, there is a need for a technology that is able to estimate a mode of an application based on network traffic patterns and so forth.

### <Packet Capture>

As a technique for identifying a traffic type based on network traffic, there is a protocol identification technology. The protocol identification technology captures a packet (frame), which is a protocol data unit (PDU) flowing through a network, using a packet capture (packet monitor), analyzes a header of each packet, and extracts and displays, for instance, a source, a destination, a protocol (for instance TCP (Transmission Control Protocol), HTTP (Hypertext Transfer Protocol), etc.), a length (byte counts) and detailed information of the packet, and actual data content. Note that PDU is referred to as “frame” in a data link layer (layer 2 (L2)) and as “packet” in a network layer (layer 3 (L3)) of OSI (Open Systems Interconnection) Reference Model by ISO (International Organization for Standardization). Further, PDU is referred to as “segment” in TCP and “datagram” in UDP (User Datagram Protocol) of a transport layer (layer 4 (L4)).

There is known a product in which a software implementing a packet capture function is installed on a computer node to monitor packets. For instance, as illustrated in FIG. 1A, a monitoring apparatus (packet monitoring apparatus) 4 equipped with a packet capture function is connected to a switch 2 (L2 switch, L3 switch, etc.) provided in a communication network 5, and captures packets (frames) flowing through the communication network 5, for instance, packets (frames) exchanged between a terminal 1 and a server 3. By mirroring(copying) one or more ports to be monitored (copy source ports) to a port (copy destination port) connected to the monitoring apparatus 4, which captures packets, in the switch 2, the monitoring apparatus 4 is enabled to monitor all packets (transmitted packets and received packets) passing through the one or more ports (copy source ports) of the switch 2. Further, the mirroring in the switch 2 may be done using a VLAN (Virtual LAN (Local Area Network)) ID (Identifier). Further, the terminal 1 may be enabled to capture packets that flow into the terminal 1 by implementing the packet capture function in the terminal 1. In an apparatus equipped with the packet capture function to implement monitoring packets that flow through a network, a network card is set to promiscuous mode to capture also signals that are not data packets destined thereto. Note that capturing a frame will be also referred to as packet capture when it is not necessary to distinguish between a fame and a packet. FIG. 1B is a diagram illustrating how traffic obtained by capturing packets changes over time within the same application (same session). The horizontal axis indicates time and the vertical axis bytes count per unit time. By determining the mode in real time from the traffic information, it becomes possible to grasp in real time the bandwidth and the transmission deadline required for each application at a given moment.

Further, in protocol determination using packet capture, for instance, for a single session, the protocol is determined based on a fixed amount of packets from the start of the session.

### <Application Mode Analysis>

A single session is, however, assumed to always operate in an identical protocol. Therefore, a protocol cannot be used directly to analyze modes of an application.

As used herein, a mode of an application refers to an operation unit of the application, which is obtained by partitioning temporally operation of the application into plural units meaningful for the application. A different mode will have a different traffic pattern in a network. Between a terminal and an application server, examples of modes include Mode 1 (transferring a large amount of data), Mode 2 (periodic data transfer), and Mode 3 (idle) (refer to FIG. 27 described later), though not limited thereto.

Further, in a case of a sensor (IoT (Internet of Things) sensor) comprising a communication function, examples of modes include periodic data transmission, unscheduled data transmission, sleep, etc. In a case of a self-driving automobile, examples of modes include driving on a high traffic road, driving on a low traffic road, and stop.

### <Protocol Learning and Determination>

For instance, Non-Patent Literature 1 discloses a technology that classifies network traffic using supervised machine-learning. This technology classifies traffic (per TCP connection) for each application category using a supervised Naive Bayes classifier. As input, feature values (flow duration, TCP port, packet arrival interval (mean, variance, etc.), payload size (mean, variance, etc.), effective bandwidth based upon entropy, and Fourier Transform of the packet arrival interval) obtained from a terminated TCP connection and category information of the communication in the TCP connection are used. As output, for instance, the following classification results for each application category (network traffic allocated to each category) are obtained.

### BULK: ftp

DATABASE: postgres, sqlnet, oracle, ingres
INTERACTIVE: ssh, klogin, rlogin, telnet
MAIL: imap, pop2/3, smtp
SERVICES: X11, dns, ident, ldap, ntp

### WWW: www

### P2P: KaZaA, BitTorrent, GnuTella

ATTACK: Internet worm and virus attacks

### GAMES: Half-Life

### MULTIMEDIA: Window Media Player, Real

Since the disclosure of Non-Patent Literature 1 utilizes duration (flow duration) of a flow (TCP connection), connection must be terminated. It is noted that the Naïve Bayes classifier is a classifier which is based on Bayes' theorem that assumes that each feature vector of each class has a Gaussian distribution. It is known that the Naïve Bayes classifier can be applied to a complex situation using a simple calculation method. Feature vectors and labels are learned as training data and supplied feature vectors are classified into labels in a classification phase.

FIGS. 2A and 2B are diagrams based on the disclosure of Non-Patent Literature 1. FIGS. 2A and 2B schematically illustrate the learning and classification phases of a comparative example, respectively. In the learning phase, associations between traffics and protocols are learned offline in advance in supervised learning. In the classification phase, a protocol is classified based on traffic information. More specifically, with reference to FIG. 2A, in the learning phase, a large amount of data sets for learning is learned offline in advance. A protocol learner 201 receives traffic data 202 for learning and training data 203 for learning (correct answer) (protocol name: HTTP (Hypertext Transfer Protocol) in the case of FIG. 2A) and creates (updates) a protocol learning model 204.

In FIG. 2B, a protocol determiner 205 receives actual traffic data 206, determines the protocol of the actual traffic data 206 based on the protocol learning model 204, and outputs a determination result 207 in the classification phase. The actual traffic data 206 determined in the classification phase is called “actual traffic data” because it is actual traffic data as opposed to the traffic data 202 for learning. The determination result 207 may be stored in a storage apparatus or outputted to a display apparatus. It is noted that the protocol learning model 204 is not updated in the classification phase in FIG. 2B.

The following discusses an example using the method schematically illustrated in FIGS. 2A and 2B for real-time determination. As illustrated in FIG. 3A, in the method illustrated in FIGS. 2A and 2B, learning and determination are performed using information sampled within a specific time/number of packets (a window 209) from the start of a session 208. The window indicating a time interval (time window) may be a length in packets (frames). Further, since the purpose of the technique illustrated in FIGS. 2A and 2B is to determine a protocol of a single session 208 (for instance HTTP, FTP (File Transfer Protocol), etc.), it cannot be used directly to determine a mode of an application. Further, a start of a session may correspond to a time when, for instance, a TCP connection is established, though not limited thereto. As is well known, a TCP connection is established by three-way handshaking between hosts (nodes) including setting a SYN (Synchronize) bit and an ACK (Acknowledge) bit of TCP headers, monitoring of which allows to detect a start of a session. Further, nodes are disconnected by performing four handshakes setting a FIN (Finish) bit and an ACK bit of TCP headers, monitoring of which allows to detect a disconnection of the session.

What mode determination needs to do is to determine each of modes divided in time-series according to traffic, as schematically illustrated in FIG. 3B. For instance, a mode determination function would obtain time-series of modes M1, M2, M3, . . . , for traffic data. The protocol identification technology disclosed in Non-Patent Literature 1 cannot be used to determine modes of an application, as illustrated in FIG. 3A.

Further, as a technology that monitors packets flowing through a network, and identifies a network application to detect unauthorized access, for instance, Patent Literature 1 discloses a method for identifying a network application by analyzing codes included in a payload rather than packet header information in order to solve problems that a large amount of packets or flows must be observed to identify an application and that an identification accuracy by an identification technique alone is insufficient due to limited observable information. The method of Patent Literature 1 includes a packet observation process of obtaining packets from network traffic, a histogram extraction process of dividing a packet payload into codes of an arbitrary bit length for each of k packets (k is a natural number not less than 2) obtained in the packet observation process and generating a histogram based on how often each code which is obtained in the divided portions of the packet payload, appears; a similarity evaluation process of evaluating changes in the configuration of the packet payload based on changes in code distribution among k histograms generated by the histogram extraction process; and a detection process of identifying an application type based on the configuration changes of the packet payload evaluated in the similarity evaluation process, and identifies a network application by sequentially executing each of the processes above.

Further, for instance, in malware detection and DLP (Data Loss Prevention) fields, Patent Literature 2 discloses a configuration in which a similarity evaluation apparatus that evaluates similarity between a comparison source file and a comparison target file generates comparison source section feature values and comparison target section feature values indicating a predetermined entropy value of each section of comparison source divided files and comparison target divided files obtained by dividing the comparison source file and the comparison target file into a plurality of sections, performs correction of each of the comparison source section feature values and the comparison target section feature values by means of DP (Dynamic Programming) matching, compares each section of the corrected comparison source section feature value and the corrected comparison target section feature value, and evaluates the similarity between the comparison source file and the comparison target file in a system that derives the entropy value of a file and evaluates the similarity of files using the entropy value. In the disclosure of Patent Literature 2, the matching accuracy is improved by shifting divided data blocks back and forth using DP. It is, however, not possible to remove a noise itself which is mixed in the learning model.

Further, Patent Literature 3 discloses a configuration of a learning apparatus facilitating learning of time-series patterns which serves as elements constituting time-series data. The learning apparatus extracts, for instance, N pieces of data for model learning from the time-series data by shifting the position of a window, derivers an i-th item of the data for model learning to an i-th learning module and each learning module performs update-learning to update model parameters that define a pattern learning model using the data for model learning. In the disclosure of Patent Literature 3, a learning accuracy is improved by adding a data extraction part that divides the data for learning into a plurality of blocks and distributes the data to learning modules. It is based on a premise that entire data to be learned is available in advance. Accordingly, the learning apparatus in the Patent Literature 3 cannot be used for real-time mode determination using a packet sequence.
[Patent Literature 1]
Japanese Patent Kokai Publication No. JP2008-141618A
[Patent Literature 2]
Japanese Patent Kokai Publication No. JP2016-66135A
[Patent Literature 3]
Japanese Patent Kokai Publication No. JP2009-288933A

### Non-Patent Literature

[Non-Patent Literature 1]
Andrew W. Moore, Denis Zuev, “Internet Traffic Classification Using Bayesian Analysis Techniques,” SIGMETRICS '05 (Proceedings of the 2005 ACM SIGMETRICS international conference on Measurement and modeling of computer systems), Jun. 6-10, 2005, Banff, Alberta, Canada.

### SUMMARY

The following gives an analysis of related technologies.

In order to ensure QoS or QoE for each mode of an application in a networked system, it is desirable to realize a technology that accurately determines a mode in real time, based on, for instance, network traffic data.

Further, if one tries to apply the protocol identification technology described with reference to FIGS. 2A and 2B to application mode determination, accurate determination of modes cannot be provided. For instance, there will be frequent occasions in which modes for a packet sequence with a small amount of information are mis-judged (this will be discussed later).

The present invention has been invented in view of the above and it is an object of the invention to provide an apparatus, system, method, and non-transitory computer readable medium, each capable of improve determination accuracy, in monitoring traffic to perform mode determination in real-time.

According to an aspect of the present invention, there is provided a mode determination apparatus comprising:

a processor; and

a memory storing program instructions executable by the processor,

wherein the processor is configured to execute:

a filter process that receives traffic data for learning to learn, by using training data, a timing of mode switching in the traffic data for learning;

a mode learning process that generates a mode learning model to be used for mode determination, based on the traffic data for learning and the training data that correspond to the timing of mode switching; and

a mode determination process that determines, by using the mode learning model, a mode of actual traffic data received.

According to another aspect of the present invention, there is provided a mode determination method using a computer, comprising:

a filtering process that includes

receiving traffic data for learning and performing learning of timing at which mode switching in the traffic data occurs, using training data;

a model learning process that includes

generating a mode learning model used for mode determination, based on the traffic data for learning and the training data that correspond to the timing of mode switching; and

a mode determination process that includes

determining a mode of actual traffic data received, using the mode learning model.

According to yet another aspect of the present invention, there is provided a network system comprising a mode determination apparatus that includes: a filter that receives traffic data for learning and performs learning of timing at which mode switching in the traffic data occurs, using training data; and a mode learning part that generates a mode learning model for mode determination, based on the traffic data for learning and the training data that correspond to the timing of the mode switching, wherein mode determination apparatus determines a mode of traffic data, using the mode learning model; and a network control apparatus that controls the traffic of a network based on a result of mode determination by the mode determination apparatus.

According to yet another aspect of the present invention, there is provided a program causing a computer to execute:

a filtering process of receiving traffic data for learning and performing learning of timing at which mode switching in the traffic data occurs, using training data; a model learning process of generating a mode learning model for mode determination based on the traffic data for learning and the training data that correspond to the timing of mode switching; and a mode determination process of determining a mode of actual traffic data, using the mode learning model.

According to the present invention, there is provided a computer readable recording medium (non-transitory computer readable recording medium, such as for instance, a semiconductor storage (such as RAM (Random Access Memory), ROM (Read Only Memory), or EEPROM (Electrically Erasable and Programmable ROM)), HDD (Hard Disk Drive), CD (Compact Disc), or DVD (Digital Versatile Disc)) that stores the program above.

According to the present invention, it becomes possible to improve determination accuracy, in monitoring traffic to perform mode determination in real-time. Still other features and advantages of the present invention will become readily apparent to those skilled in this art from the following detailed description in conjunction with the accompanying drawings where only exemplary embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF DRAWINGS

FIG. 1A is a diagram illustrating an example of packet capture.

FIG. 1B is a diagram illustrating an example of traffic monitoring by means of packet capture.

FIG. 2A is a diagram illustrating a related technology.

FIG. 2B is a diagram illustrating the related technology.

FIG. 3A is a diagram illustrating functions of protocol determination.

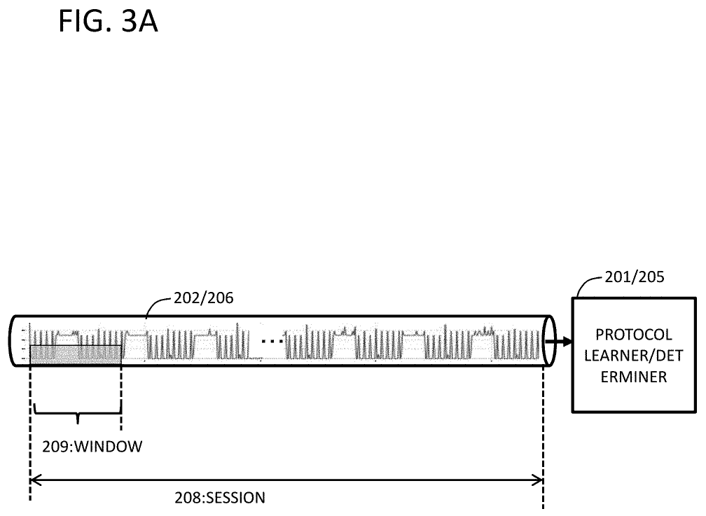

FIG. 3B is a diagram illustrating the function of mode determination.

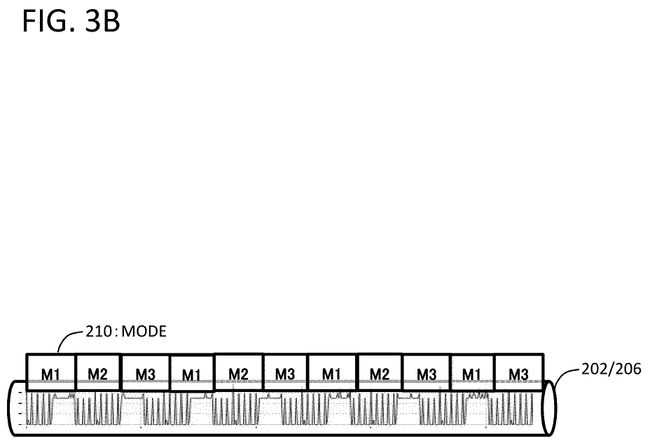

FIG. 4A is a diagram illustrating a comparative example.

FIG. 4B is a diagram illustrating the comparative example.

FIG. 5A is a diagram illustrating the time-series transition of modes.

FIG. 5B is a diagram illustrating the time-series transition of modes.

FIG. 5C is a diagram illustrating the operation of the comparative example.

FIG. 6 is a diagram illustrating a learning phase of a mode of the present invention.

FIG. 7 is a diagram illustrating a determination phase of a mode of the present invention.

FIG. 8A is a diagram illustrating a 2-step learning operation in an embodiment of the present invention.

FIG. 8B is a diagram illustrating a two-stage determining operation in an embodiment of the present invention.

FIG. 8C is a diagram schematically explaining a first-stage operation in an embodiment of the present invention.

FIG. 9 is a diagram illustrating (a) an example of traffic; (b) how modes time-series change; (c) how modes time-series change as determined in an embodiment of the present invention; and (d) how modes time-series change as determined in the comparative example.

FIG. 10 is a diagram illustrating an example embodiment of a network system relating to the present invention.

FIG. 11 is a diagram illustrating a configuration example of a mode determination apparatus according to a first example embodiment of the present invention.

FIG. 12 is a diagram illustrating a configuration example relating to learning by the mode determination apparatus according to the first example embodiment of the present invention.

FIG. 13 is a diagram schematically illustrating an example of a training data DB according to the first example embodiment of the present invention.

FIG. 14 is a flowchart illustrating a learning operation of the mode determination apparatus according to the first example embodiment of the present invention.

FIG. 15 is a diagram illustrating step S13 in FIG. 14 of the present invention.

FIG. 16 is a diagram illustrating a configuration example relating to a determination phase of the mode determination apparatus according to the first example embodiment of the present invention.

FIG. 17 is a flowchart illustrating a determination operation of the mode determination apparatus according to the first example embodiment of the present invention.

FIG. 18 is a diagram schematically illustrating an example of a timing learning model of the mode determination apparatus according to the first example embodiment of the present invention.

FIG. 19 is a diagram illustrating a configuration example of a learning filter part according to the first example embodiment of the present invention.

FIG. 20 a drawing illustrating a configuration example of a mode learning part according to the first example embodiment of the present invention.

FIG. 21 is a diagram illustrating a configuration example of a mode determination part according to the first example embodiment of the present invention.

FIG. 22 is a diagram illustrating a configuration example of a mode determination apparatus according to a second example embodiment of the present invention.

FIG. 23 is a flowchart describing the operation of the mode determination apparatus according to the second example embodiment of the present invention.

FIG. 24 is a diagram illustrating a configuration example of a mode determination apparatus according to a third example embodiment of the present invention.

FIG. 25 is a flowchart describing the operation of the mode determination apparatus according to the third example embodiment of the present invention.

FIG. 26 is a diagram illustrating a configuration example of a mode determination apparatus according to a fourth example embodiment of the present invention.

FIG. 27 is a diagram illustrating another example embodiment of the network system relating to the present invention.

### DETAILED DESCRIPTION

According to an embodiment of the present invention, a mode determination apparatus comprises a filter part and a mode learning part.

The filter part receives traffic data for learning and training data, performs learning of timing at which mode switching in the traffic data occurs and generates (updates) a timing learning model.

The mode learning part generates (updates) a mode learning model used for mode determination, based on the traffic data for learning and the training data that correspond to the timing of the mode switching.

The mode determination apparatus may be configured to include a mode determination part that performs mode determination of actual traffic data, using the mode learning model.

The mode determination part receives actual traffic data and determines modes for data (actual traffic data) corresponding to timing information of the timing learning model, using the mode learning model.

Further, the filter part generates the timing learning model using the traffic data for learning and the training data, and judges traffic based on the learning model. In order to clarify this point, the filter part is also referred to as, for instance, “learning filter” or “learning-type filter.”

According to an embodiment of the present invention, learning and determination may be performed by selecting, for instance, a start timing of a mode that includes a lot of information which is effective in determining the mode.

According to an embodiment of the present invention, a learning filter that determines a timing in which mode determination is performed is provided before a mode learner that learns modes, and 2-step learning and 2-step determination are performed. According to the mode of the present invention, the determination accuracy in real-time mode determination can be improved.

### COMPARATIVE EXAMPLE

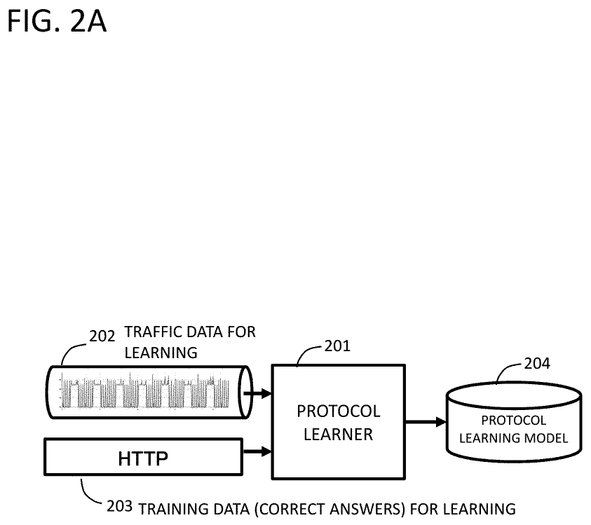

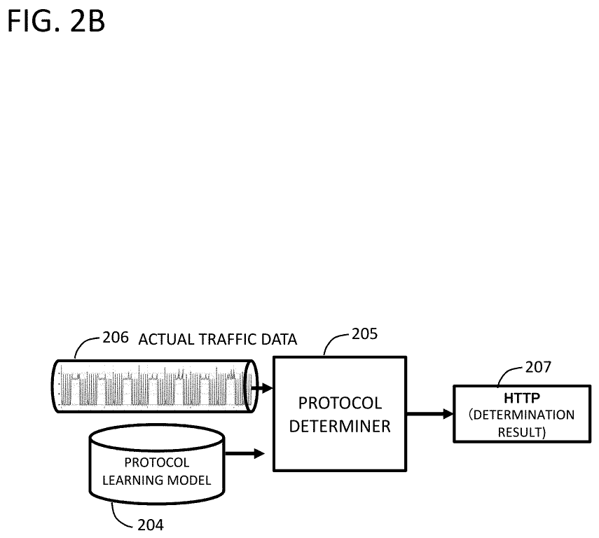

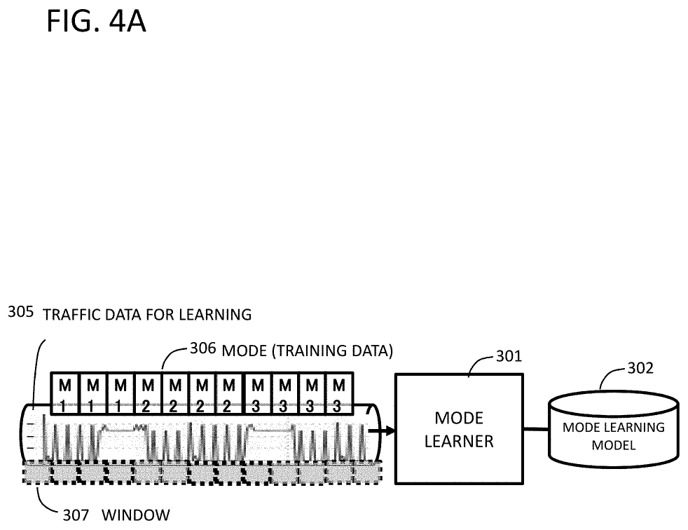

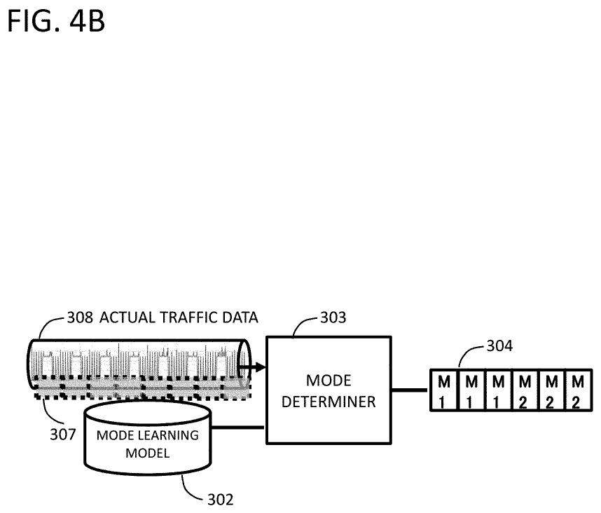

The following describes a comparative example, in which the protocol identification technology described with reference to FIGS. 2A and 2B is applied to real-time mode determination. FIGS. 4A and 4B are diagrams illustrating a learning phase and a determination phase of the comparative example, respectively. Referring to FIG. 4A, traffic data 305 for learning is divided by windows 307, and a mode learner 301 learns a mode for each window of the traffic data 305 for learning based on a mode (training data) 306 set for each window 307 and creates a mode learning model 302. In other words, the mode learner 301 learns a different learning data set for each window 307.

Referring to FIG. 4B, in the determination phase, a mode determiner 303 receives actual traffic data 308, determines a mode of the actual traffic data 308 on a per window 307 basis, using the mode learning model 302, with not being supervised, and outputs a determination result 304.

For instance, a decision tree may be used as the mode learning model 302, though not thereto. A decision tree is a tree structure for classifying data expressed by sets of attributes and the values thereof {attribute 1=value 1, . . . , attribute n=value n} into several classes. Each internal node of a decision tree is labeled with an attribute, branches from the internal node have possible values of the attribute, and a leaf node is the final classification. In a determination phase, data in the (attribute, value) format is supplied to a learning model decision tree, and a leaf node classification reached via branches of internal nodes from the root while testing the values of the attributes is outputted as the determination result. A mode learning part 101 may use, for instance, ID3 (Iterative Dichotomiser 3), CART (Classification and Regression Tree), or random forests as a supervised learning algorithm for outputting a decision tree.

In the above comparative example in which the protocol identification technology is applied to simple mode determination, modes will be frequently misjudged. This is because learning and determination is performed at parts having small differences in an amount of information other than the switching points of packet sequence modes, which are not suitable for learning/determination.

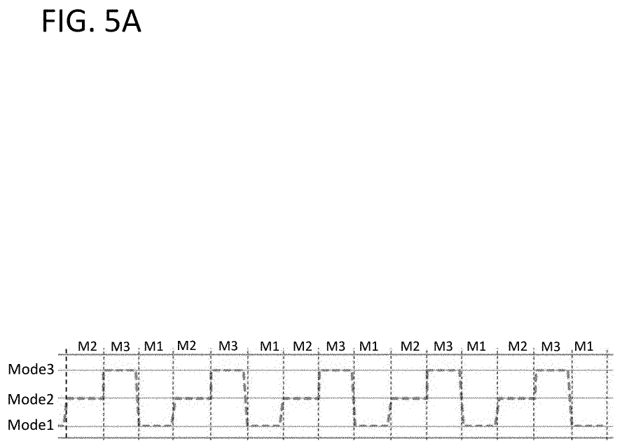

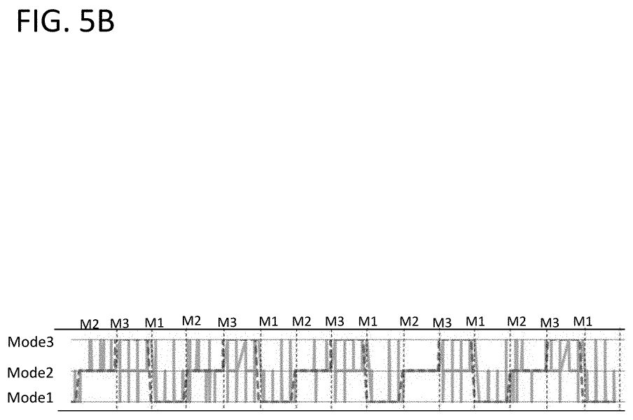

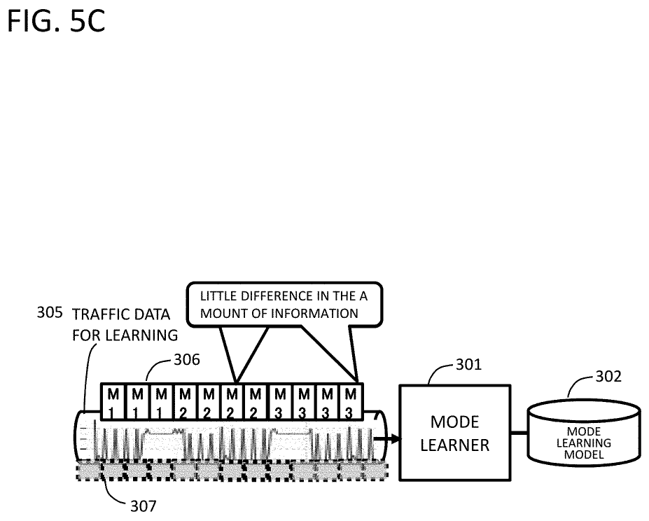

FIGS. 5A and 5B are diagrams each illustrating an example of the determination results in the comparative example described with reference to FIGS. 4A and 4B. FIG. 5A is a diagram illustrating the time-series transition of actual traffic of modes. The example in FIGS. 5A and 5B has only three modes: Modes 1 to 3 (M1 to M3), though not limited thereto. In FIG. 5B, solid lines indicate determination results by the mode determiner 303 in FIG. 4B for the same traffic data illustrated in FIG. 5A (the comparative example). Further, dashed lines in FIG. 5B correspond to the time-series mode transition in FIG. 5A. As illustrated in FIG. 5B, whereas the mode transitions from Mode 1 (M1) to Mode 2 (M2) and should stay in Mode 2 (M2) for a certain period of time, it transitions back and forth between Mode 2 (M2) and Mode 3 (M3) several times. As mentioned above, this is because the traffic data for learning was learned for each of windows having the same time length, and learning/determination is performed with packet sequences which are not suited to learning/determination. In other words, as illustrated in FIG. 5C, learning/determination is performed for portions with a small difference in an amount of information between windows (portions other than mode switching points) and a mechanism capable of performing selective learning for portions with a large difference in an amount of information therebetween is not provided.

### EMBODIMENTS

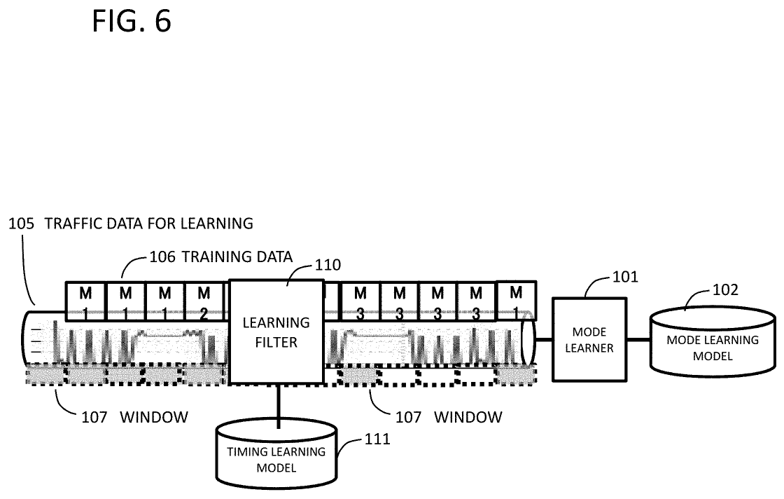

In an embodiment of the present invention, with reference to FIG. 6, a learning filter 110 that indicates timing at which a mode is determined is provided before the mode learner 101 that determines a mode. The learning filter 110 receives traffic data 105 for learning and training data (mode) 106, learns timing inclusive of a lot of information effective for mode determination and indicates the timing to the mode learner 101. In FIG. 6, white space windows out of dashed line windows 107 are not notified to the mode learner 101. It is noted that a length of the window 107 representing a time interval (time window) may be a length corresponding to a plurality of packets (frames) on a per packet (frame) basis.

The mode learner 101 receives the traffic data 105 for learning, the training data (mode) 106, and the timing information detected by the learning filter 110 and performs learning of modes, using timings (windows) each containing a lot of information effective for mode determination. As the timing, for instance, a start time of a mode may be used. The mode learner 101 performs learning of modes, using traffic data of intervals (time windows), in each of which difference in amount of information between modes is large. As a result, an accuracy in mode learning may be improved. In addition, since mode learning/determination is performed only at timing suitable for mode determination, an accuracy in mode determination may be improved.

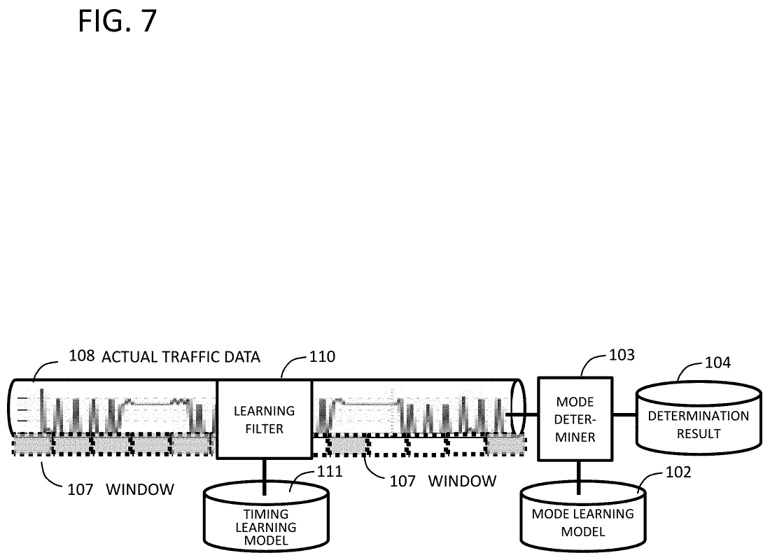

Referring to FIG. 7, the learning filter 110 receives actual traffic data 108 and notifies a mode determination part 103 of the windows 107 which correspond to timing information of a timing learning model 111. In FIG. 7, white space windows out of the dashed line windows 107 are not notified to the mode learner 101.

The mode determination part 103 determines modes of traffic data (traffic data suitable for mode determination) corresponding to the windows 107 notified by the learning filter 110 using a mode learning model 102.

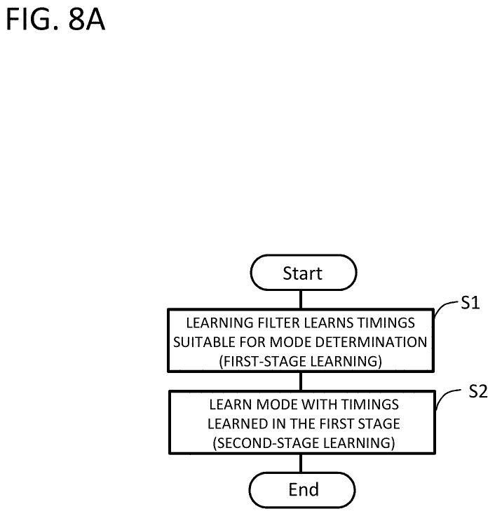

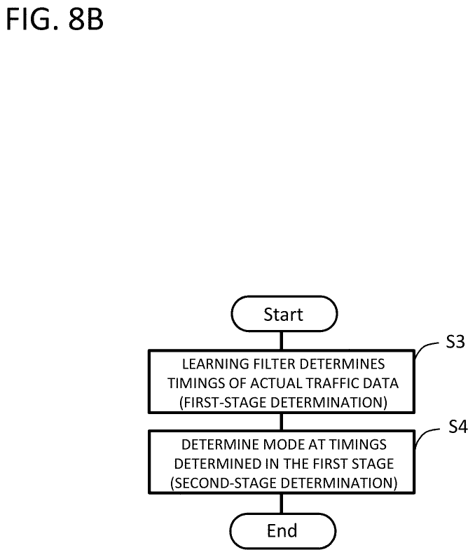

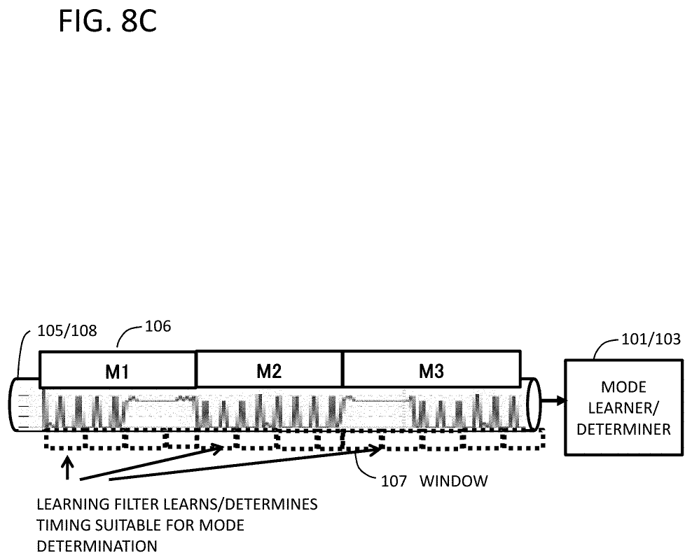

FIG. 8A is a diagram illustrating an operation principle of learning according to one mode of the invention. In a learning phase, a first-stage learning filter 110 (the first stage means that the learning filter 110 is arranged at a stage preceding to that of the mode learning part 101) receives traffic data for learning and training data, and learns timings suitable for learning modes (for instance, mode switching timings) (a first-stage learning: S1).

The second-stage mode learner 101 receives the traffic data for learning and the training data and learns modes at the timings suitable for learning modes (for instance, mode switching timings) (a second-stage learning: S2).

FIG. 8 B is a diagram illustrating an operation principle of determination according to one mode of the invention. In a determination phase, the first-stage learning filter 110 receives actual traffic data and determines mode switching timings, using the timing learning model that the learning filter 110 has learned (a first-stage determination: S3).

The second-stage mode determination part 103 determines modes at the timings learned by the first-stage learning filter 110 (a second-stage determination: S4).

FIG. 8C is a diagram illustrating the timing learning and determination process by the first-stage learning filter 110. In the learning phase, the first-stage learning filter 110 receives the traffic data 105 for learning, learns timings suitable for mode determination (mode switching timings) using the training data (mode) 106, and supplies the traffic data 105 for learning and the timing information (the window 107) to the mode learner 101. In the determination phase, the first-stage learning filter 110 receives actual traffic data 108, determines timings suitable for mode determination (mode switching timings) based on the timing learning model that the learning filter 110 has learned and supplies the actual traffic data 105 and the timing information suitable for mode determination (the windows 107) to the mode determination part 103. The training data 106 is not supplied in the determination phase.

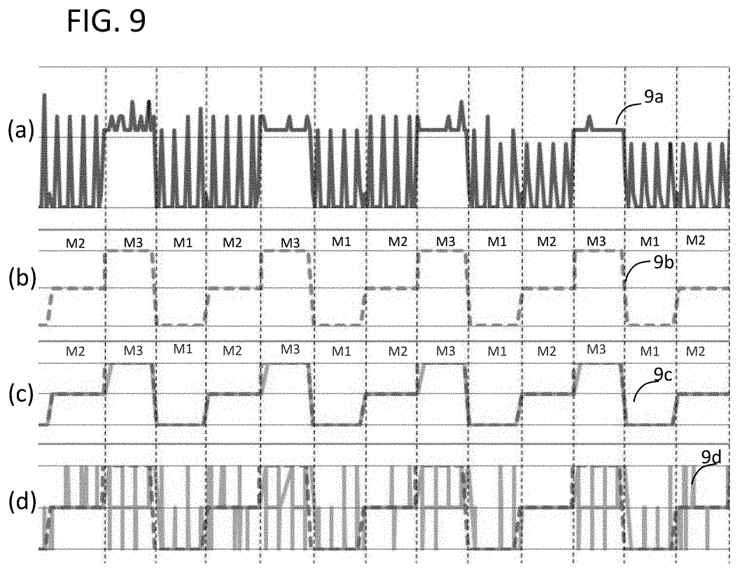

In FIG. 9, 9a in (a) is an example of traffic, a dashed line 9b in (b) is a time-series of modes (actual modes) in (a), a solid line 9c in (c) is a time-series of modes determined by a mode determination apparatus 10 according to an aspect of the present invention, a dashed line in (c) is time series of modes (actual modes) in (b), a solid line 9d in (d) is time-series of modes determined in the comparative example, and a dashed line in (d) is times series of modes (actual modes) in (b).

As is clear from the comparison between 9c (modes determined according to an aspect of the present invention) in (c) and 9d (modes determined in the comparative example) in (d) in FIG. 9, according to an aspect of the present invention, an accuracy in mode determination is significantly improved, as compared with the comparative example.

### <An Example Embodiment of a Network System>

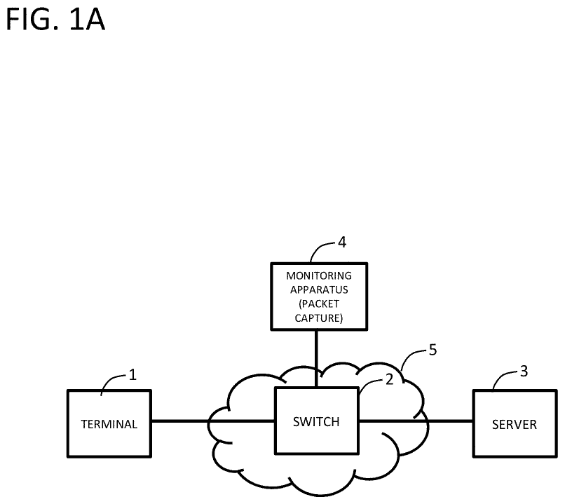

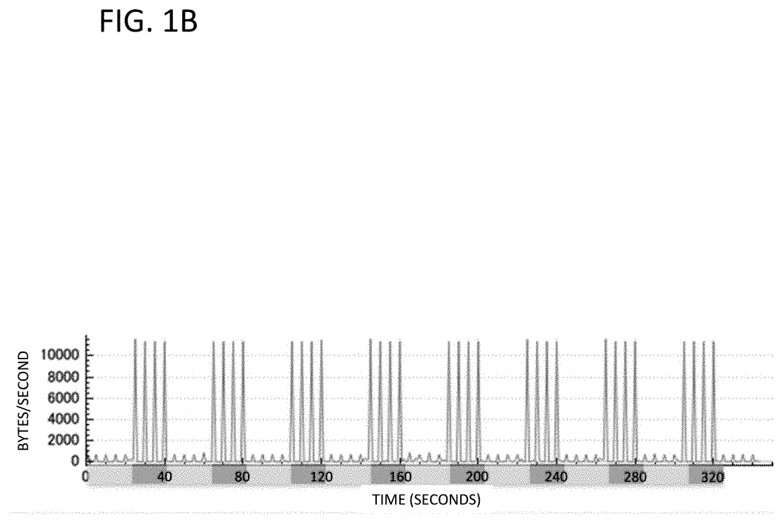

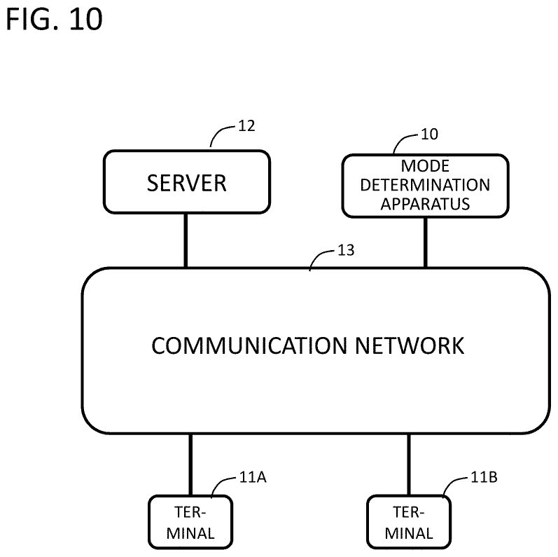

FIG. 10 is a diagram illustrating a configuration example of a network system according to an example embodiment of the present invention. Terminals 11A and 11B communicate with a server 12 via a communication network 13. The server 12 may be an application server, a web server, or a server that provides various kinds of cloud services. It is noted that only two terminals 11A and 11B are illustrated in FIG. 10 for the sake of simplicity, however, the number of terminals is not limited. The mode determination part 10 captures packets flowing through the communication network 13 and analyzes traffic data to determines modes. Further, the mode determination apparatus 10 may be connected to a port of a switch (not illustrated) provided in the communication network 13 as illustrated in FIG. 1A and capture packets flowing through a copy source port (packets exchanged between the terminals 11A and 11B and the server 12). The mode determination apparatus 10 may capture packets transmitted/received by/from the terminals 11A and 11B via the communication network 13. Several example embodiments of the mode determination apparatus 10 will be described below.

### Example Embodiment 1: Mode Determination Apparatus

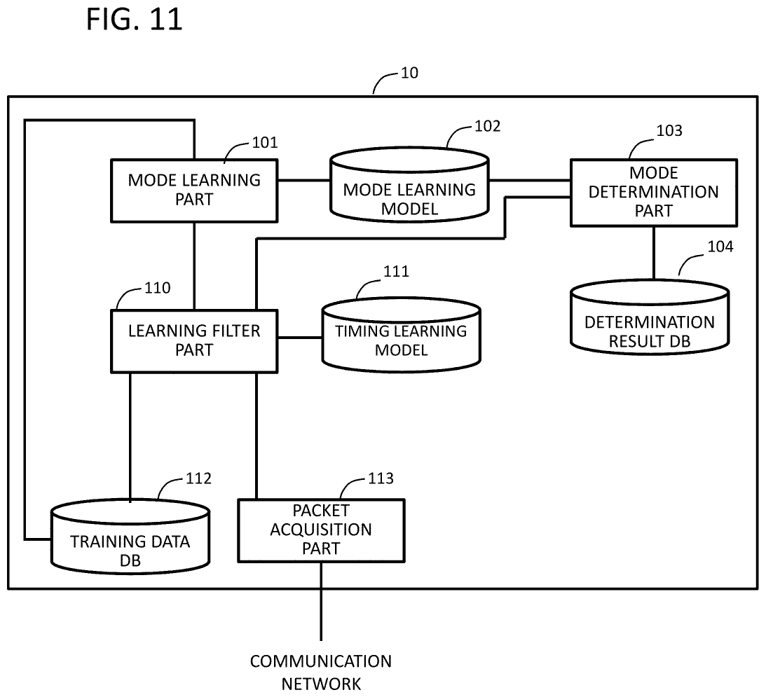

FIG. 11 is a diagram illustrating the mode determination apparatus 10 according to a first example embodiment. Referring to FIG. 11, the mode determination apparatus 10 includes a mode learning part 101, a mode determination part 103, a packet acquisition part 113, a learning filter part 110, a training data DB (database) 112, a mode learning model 102, a timing learning model 111, and a determination result DB 104. The mode learning part 101 corresponds to the mode learner 101 in FIG. 6. The mode determination part 103 corresponds to the mode determination part 103 in FIG. 7 described above. The learning filter part 110 corresponds to the learning filter 110 in FIGS. 6 and 7 described above. The mode learning model 102 corresponds to the mode learning model 102 in FIGS. 6 and 7 described above. The timing learning model 111 corresponds to the timing learning model 111 in FIGS. 6 and 7 described above.

In FIG. 11, the packet acquisition part 113 may be configured to be connected to a switch (not illustrated) of the communication network 13 in FIG. 10. At least two of the training data DB (database) 112, the mode learning model 102, the timing learning model 111, and the determination result DB 104 may be configured to be stored in different storage apparatuses. Alternatively, they may be configured to be stored in the same storage apparatus. The mode learning part 101, the mode determination part 103, the packet acquisition part 113, and the learning filter part 110 may be implemented on different nodes communicably connected with each other, or may be implemented within a single apparatus.

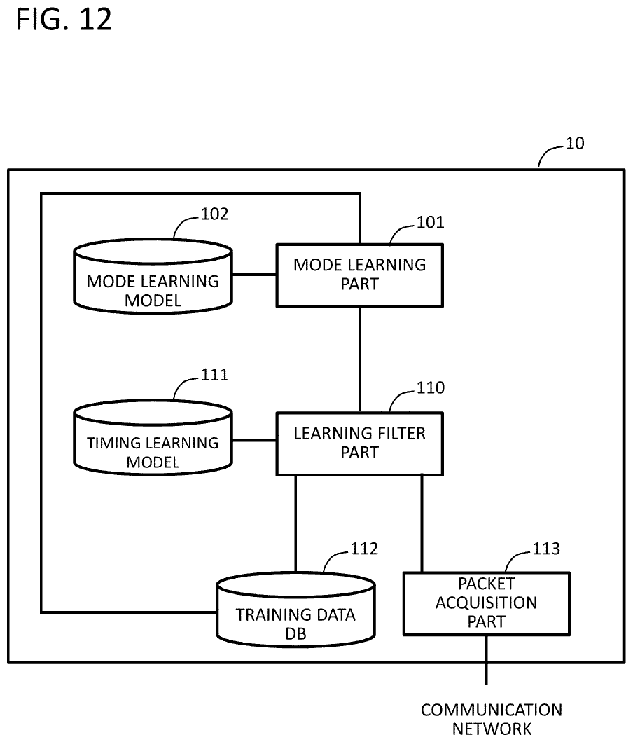

FIG. 12 is a diagram illustrating a function configuration relating to a learning phase of the mode determination apparatus 10 of the first example embodiment illustrated in FIG. 11. Referring to FIG. 12, the learning filter part 110 receives a packet sequence (traffic data for learning) from the packet acquisition part 113 and obtains, for instance, mode information corresponding to the packets from the training data DB 112. The learning filter part 110 extracts feature values (e.g., packet size (byte counts) or packet arrival interval) from a packet sequence, learns timings containing a lot of information useful to determine modes based on the feature values, and creates the timing learning model 111. The learning filter part 110 notifies the mode learning part 101 of timing information (window) for mode learning. The learning filter part 110 may use statistics (e.g., maximum value, minimum value, mean, variance, sum, or the like) on the size (bytes count) of the packet sequence (for instance a plurality of consecutive packets) as the feature values of packets. Statistics (e.g., maximum value, minimum value, mean, variance, sum etc.) on the packet arrival interval may be used. The statistics on the packet size and the packet arrival interval may be calculated based on the headers of the packets and time-stamp information when the packets are received, respectively.

The mode learning part 101 receives the traffic data for learning, the training data, and timing information detected by the learning filter part 110, and performs learning, based on the traffic data for learning and mode information corresponding to the timing information, to create the mode learning model 102. For instance, a mode start time that contains a lot of information that are useful to determine a mode is used as the timing. The mode learning part 101 performs learning of data using time windows having large differences in units of information between modes. In the mode learning part 101, an accuracy in determining modes is improved since modes are determined only at timings suitable for mode determination.

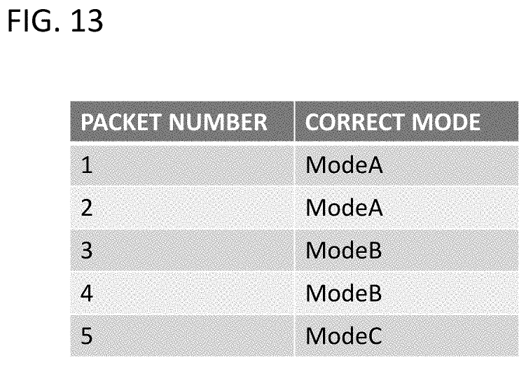

FIG. 13 schematically describes an example of the content of the training data DB 112. The training data DB 112 stores correct mode information for each packet number. In the first example embodiment, it is assumed that the training data DB 112 is set and registered in advance. FIG. 13 shows different modes for each packet, however, a plurality of consecutive packets may, as a matter of fact, belong to the same mode. Although a correct mode corresponding to a packet changes for each packet number in FIG. 13, for the sake of simplicity, a plurality of consecutive packets may have the same mode.

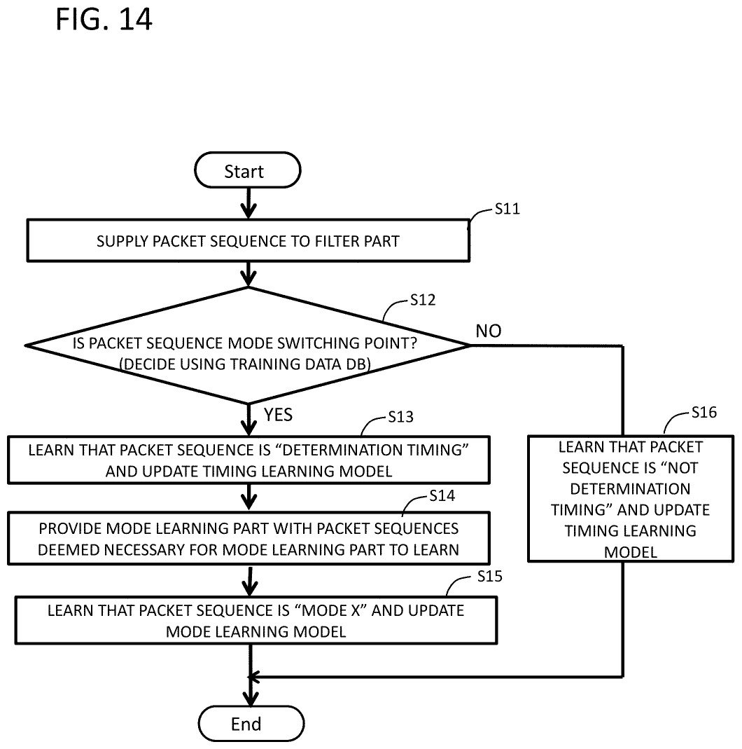

FIG. 14 is a flowchart illustrating an operation of the learning phase of the mode determination apparatus 10 according to an example embodiment illustrated in FIG. 12. In FIG. 14, step S11 is a process by the packet acquisition part 113 in FIG. 12. Steps S12 to S14 and S16 are processes by the learning filter part 110 in FIG. 12. Step S15 is a process by the mode learning part 101 in FIG. 12.

The packet acquisition part 113 supplies a packet sequence to the learning filter part 110 (S11). The learning filter part 110 receives the packets (traffic data for learning) and determines whether or not the packet sequence constitutes a mode switching point, using the training data DB 112 (S12). In the step S12, for instance, the learning filter part 110 may detect a switching point by using the following method.

The learning filter part 110 searches for a correct mode (FIG. 13) corresponding to a packet number (derived using the number of packets from the beginning of the packet sequence) of a packet supplied by the packet acquisition part 113, in the training data DB 112. The learning filter part 110 recognizes that a mode change has occurred when the correct mode (current correct mode) of the packet supplied is different from a previous correct mode (Mode Y).

Next, the learning filter part 110 learns that a point of time at which the mode change is detected is a determination timing of the packet sequence and updates the timing learning model 111 (S13). An example is given below.

The learning filter part 110 extracts a packet sequence from a current packet supplied and history information of past packets, using a predetermined window. For instance, the following describes a case wherein a current packet supplied by the packet acquisition part 113 and the last packet therebefore are extracted. The current supplied packet and the last packet are temporarily stored in a memory (not illustrated) in the learning filter part 110. The learning filter part 110 calculates feature values of the extracted packets. For instance, the feature values may be statistics (e.g., maximum value, minimum value, mean, variance, sum, etc.) on a packet size or statistics (e.g., maximum value, minimum value, mean, variance, sum, etc.) on the packet arrival interval. Size information of an entire packet stored in a header of a received packet may be extracted as the packet size. For instance, a datagram length field (16 bits) information of an IP (Internet Protocol) packet header may be extracted. Time difference between time-stamps when a packet and a previous packet are respectively received by the packet acquisition part 113 may be used as the packet arrival interval.

The learning filter part 110 learns the calculated feature values of the extracted packets in association with a fact that “the current packet is a mode switching timing” in supervised learning (updates the timing learning model).

Next, the learning filter part 110 provides the mode learning part 101 with packet sequences necessary for learning in the mode learning part 101 (S14).

The learning filter part 110 extracts a packet sequence which corresponds to predetermined windows and is to be used by the mode learning part 101 to learn modes, from the current packet and a predetermined number of past packets therebefore supplied by the packet acquisition part 113, and transmits the extracted packet sequence to the mode learning part 101.

When it is determined that a result in the step S12 does not indicate a switching point, the learning filter part 110 learns that the packet sequence is “not a determination timing” and updates the timing learning model (S16). The process in the step S16 is basically the same as that in the step S13 except for the correct data to be learned and the subsequent processes. In the step S16, the learning filter part 110 extracts a packet sequence from the supplied packet and the packet history information using predetermined windows and calculates feature values from the extracted packet sequence. The learning filter part 110 learns, using supervised learning, the calculated feature values in association with a fact that the current packets do not represent a mode switching timing.

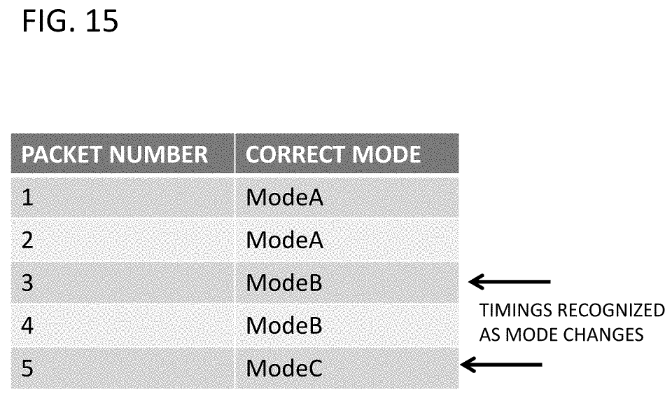

The mode learning part 101 learns that the extracted packet sequence represents Mode so-and-so (“Mode X” in FIG. 15) and updates the mode learning model 102 (S15). The mode learning part 101 calculates feature values from the packet sequence supplied by the learning filter part 110. The mode learning part 101 learns the calculated feature values and that “the packets are Mode X”, using supervised learning and updates the mode learning model 102. The learning performed by the mode learning part 101 differs from the learning performed by the learning filter part 110 in that packet sequences from which the mode learning part 101 calculates feature values, are those supplied from the learning filter part 110, and in granularity of correct data used in supervised learning (modes that may straddle a plurality of consecutive packets are learned as the correct data).

FIG. 15 is a diagram illustrating timings (containing a lot of information effective for mode determination) learned by the learning filter part 110. In an example illustrated in FIG. 15, the learning filter part 110 learns that a packet (packet number 3) represents a timing when the mode switches from a previous packet (packet number 2), updates the timing learning model 111, learns that a packet (packet number 5) represents a timing when the mode switches from a previous packet (packet number 4), and updates the timing learning model 111.

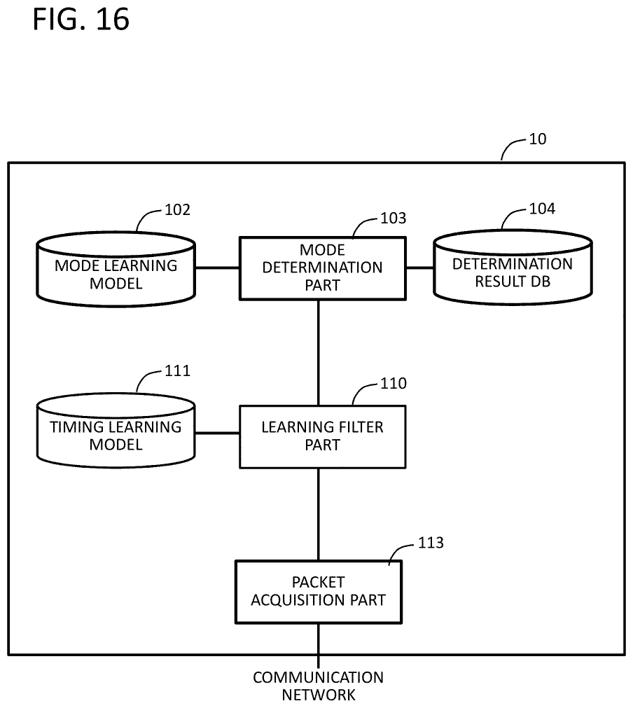

FIG. 16 is a diagram illustrating a function configuration example relating to a determination phase of the mode determination apparatus 10 of an example embodiment illustrated in FIG. 11. The learning filter part 110 receives a packet sequence (traffic data) from the packet acquisition part 113, detects timings (windows) of the traffic (packets) useful for mode determination by referring to the timing learning model 111, and notifies the mode determination part 103 thereof. The mode determination part 103 determines modes of the traffic data (suitable for determination) corresponding to the windows 107 notified by the learning filter part 110 using the mode learning model 102 and outputs a result of the determination to the determination result DB (database) 104.

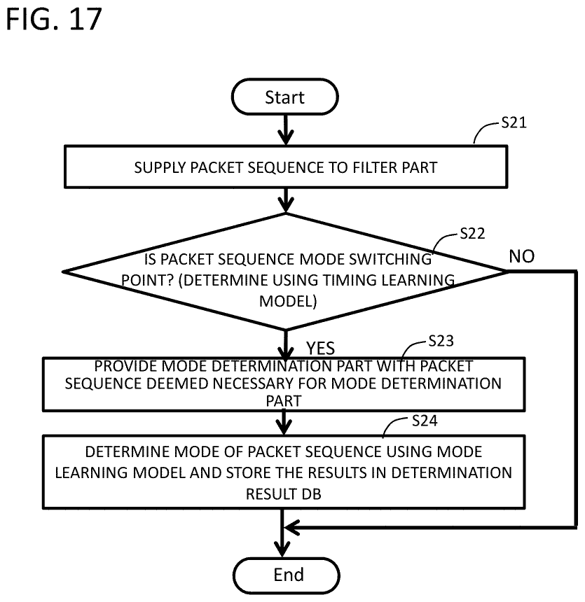

FIG. 17 is a flowchart illustrating the operation in the determination phase of the mode determination apparatus 10 according to an example embodiment illustrated in FIG. 16. Step S21 is a process by the packet acquisition part 113. In FIG. 17, steps S22 and S23 are processes by the learning filter part 110. Step S24 is a process by the mode determination part 103.

The packet acquisition part 113 supplies a packet sequence from actual traffic data to the learning filter part 110 (S21).

The learning filter part 110 receives packets (actual traffic data) and determines whether or not the packet sequence represents a mode switching point, using the timing learning model 111, based on the feature values of the packets (S22). For instance, the learning filter part 110 recognizes a switching point using the following method. The learning filter part 110 stores the packets supplied by the packet acquisition part 113, as packet history information, in a storage part not illustrated.

The learning filter part 110 extracts a packet sequence from the supplied packets and the packet history information using the same windows used in the learning phase. The learning filter part 110 calculates feature values from the extracted packet sequence. For instance, the learning filter part 110 uses the same feature values as those used in the learning phase (packet size and packet arrival interval) as the feature values (features in the determination phase).

The learning filter part 110 determines whether or not the supplied packets represent a mode switching timing, using the calculated feature values and the timing learning model 111 created in the learning phase.

The learning filter part 110 provides the mode determination part 103 with a packet sequence necessary for the mode determination part 103 to determine a mode (S23).

The mode determination part 103 determines a mode of the packet sequence supplied by the learning filter part 110, using the mode learning model 102 and stores a determination result in the determination result DB 104 (S24). For instance, the mode determination part 103 performs the following processing as the mode determination.

The mode determination part 103 calculates feature values (for instance, statistics on packet size and packet arrival interval, etc.) from the packet sequence supplied by the learning filter part 110.

The mode determination part 103 determines to which mode the packets supplied by the learning filter part 110 belong, using the calculated feature values and the mode learning model 102 created in the learning phase.

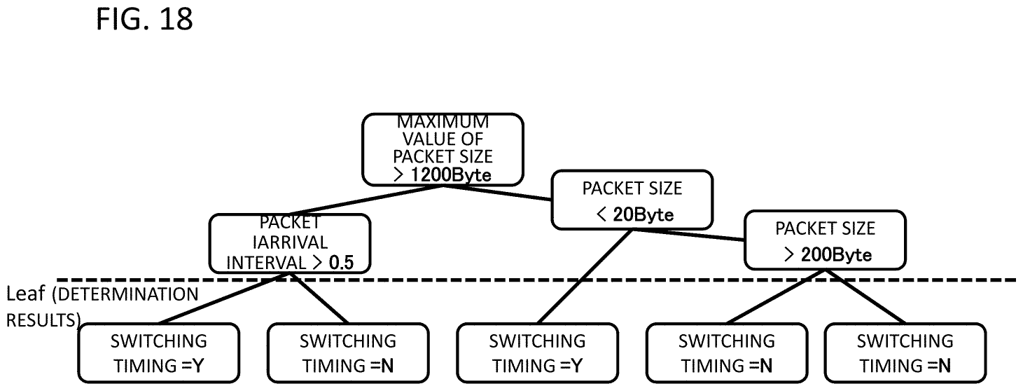

FIG. 18 is a diagram illustrating an example of the timing learning model 111 learned by the learning filter part 110 and how a mode switching timing is determined. The learning filter part 110 that creates the timing learning model 111 illustrated in FIG. 18 may create a decision tree using a learning algorithm such as ID3.5 or CART, though not limited thereto.

In the example illustrated in FIG. 18, the decision tree uses attributes (feather values: packet size and packet arrival interval) and classifies data expressed by sets of attributes and values (ranges) thereof into several classes. Leaf nodes are mode switching timings used in mode determination. In the determination phase, the learning filter part 110 supplies sets of packet sizes and packet arrival intervals which are the feature values (attributes) of packets, and the values thereof to the decision tree, and outputs classification of the leaf node, as a determination result, reached via branches of internal nodes, while testing values of the attributes from a root of the decision tree. When a statistic (the maximum value) of the packet size exceeds 1200 bytes, it is a switching timing (switching timing=Yes) if the packet arrival interval exceeds 0.5 (time unit) and it is not a switching timing (switching timing=No) if the packet arrival interval does not exceed 0.5 (time unit).

The mode learning part 101 may use ID3 or CART as the learning algorithm of the decision tree. Although FIG. 18 illustrates a learning model comprising one decision tree (classifier) for the sake of simplicity, ensemble learning (learning in which a plurality of individually learning decision trees are provided and their outputs are combined to constitute one decision tree by using, for instance, the mean thereof) such as a random forest may be used. Further, a decision tree may be used as the mode learning model 102.

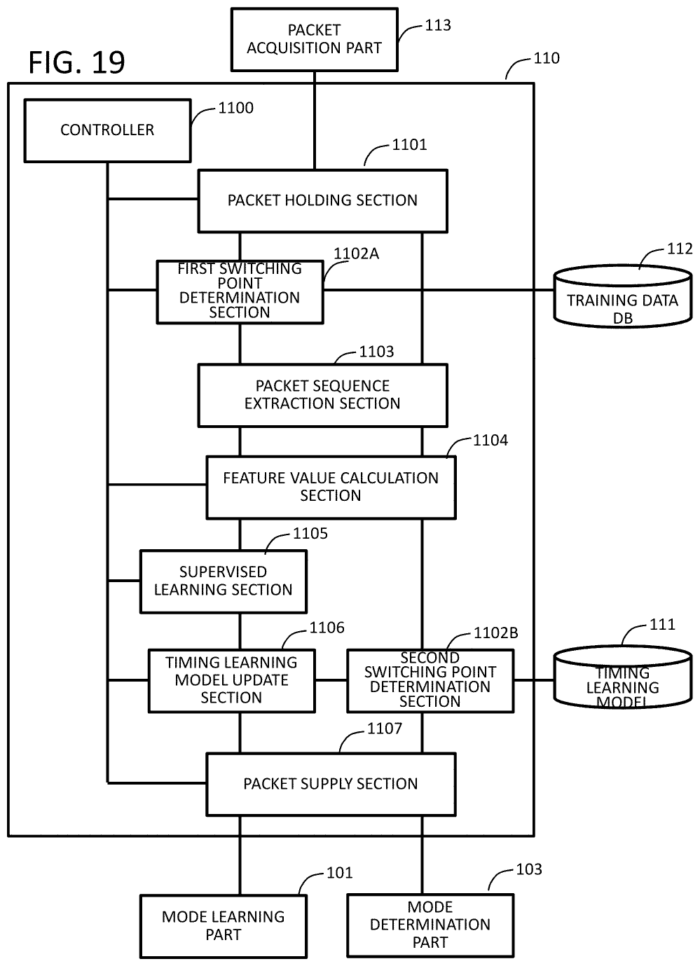

FIG. 19 is a diagram illustrating a function-block-based configuration example of the learning filter part 110 of the mode determination apparatus 10 according to the first example embodiment. Referring to FIG. 19, the learning filter part 110 comprises a controller 1100, a packet holding section (buffer memory) 1101, a first switching point determination section 1102A, a second switching point determination section 1102B, a packet sequence extraction section 1103, a feature value calculation section 1104, a supervised learning section 1105, a timing learning model update section 1106, and a packet supply section 1107.

The controller 1100 controls the operation of the learning phase and the determination phase of the learning filter part 110. For instance, the controller 1100 activates the first switching point determination section 1102A (deactivates the second switching point determination section 1102B) in the learning phase. The activated first switching point determination section 1102A determines whether or not a packet sequence represents a mode switching point by referring to the training data DB 112. Further, the controller 1100 controls the packet supply section 1107 to supply a packet sequence to the mode learning part 101 in the learning phase. Further, settings of the controller 1100 for the learning and determination phases may be entered from, for instance, a predetermined operation terminal to the controller 1100.

The controller 1100 activates the second switching point determination section 1102B (deactivates the first switching point determination section 1102A) in the determination phase. The activated second switching point determination section 1102B determines whether or not a packet sequence represents a mode switching point by referring to the timing learning model 111. The controller 1100 controls the packet supply section 1107 to supply a packet sequence extracted by the packet sequence extraction section 1103 to the mode determination part 103 in the determination phase.

The packet holding section 1101 holds a packet or packet sequence acquired by the packet acquisition part 113 in a buffer memory not illustrated in the drawing. The buffer memory of the packet holding section 1101 may be a FIFO (First In First Out) buffer of a predetermined length (capacity). The packet sequence extraction section 1103 extracts a packet sequence from the packet sequences in the packet holding section 1101 in the determination phase.

In the learning phase, the first switching point determination section 1102A determines whether or not the current packet (the last packet stored in the FIFO buffer) represents a mode switching point, based on the training data DB 112, by referring to the current packet and past packets out of the plurality of packets held in the packet holding section 1101. For instance, whether or not the current packet represents a mode switching point may be determined by referring to the training data (correct modes) of the current packet and the previous packet. When the current packet represents a switching point, the packet sequence extraction section 1103 extracts a packet sequence from the current and past packets supplied by the packet acquisition part 113 and held in the packet holding section 1101, using arbitrary windows (time windows).

The feature value calculation section 1104 receives a packet sequence extracted by the packet sequence extraction section 1103 and calculates feature values of the packets in the learning and determination phases. The feature value calculation section 1104 may use statistics on the packet size (e.g., maximum value, minimum value, mean, variance, sum etc.) as the feature values. Statistics (e.g., maximum value, minimum value, mean, variance, sum etc.) on the packet arrival interval may also be used as the feature values. The statistics on the packet size may be calculated based on headers of the packets and the statistics on the packet arrival interval may be calculated based on time-stamp information when the packets are received. It is noted that in the determination phase, the feature value calculation section 1104 calculates the same feature values as those in the learning phase.

The supervised learning section 1105 is activated by the controller 1100 in the learning phase. It learns the feature values calculated by the feature value calculation section 1104 and that the current packet represents a mode switching timing in supervised learning.

In the determination phase, the packet sequence extraction section 1103 extracts a packet sequence from the packet holding section 1101, based on an instruction from the controller 1100 and hands the packet sequence extracted to the feature value calculation section 1104. The feature value calculation section 1104 calculates feature values of the packet sequence received from the packet sequence extraction section 1103. In the determination phase, the second switching point determination section 1102B activated by the controller 1100 refers to the feature values calculated by the feature value calculation section 1104 and the updated timing learning model 111 to determine whether or not the current packet (the latest packet stored in the FIFO buffer of the packet holding section 1101) represents a mode switching timing.

Based on an instruction from the controller 1100, the packet supply section 1107 supplies packets extracted by the packet sequence extraction section 1103 to the mode learning part 101 in the learning phase, and supplies packets extracted by the packet sequence extraction section 1103 to the mode determination part 101 in the determination phase.

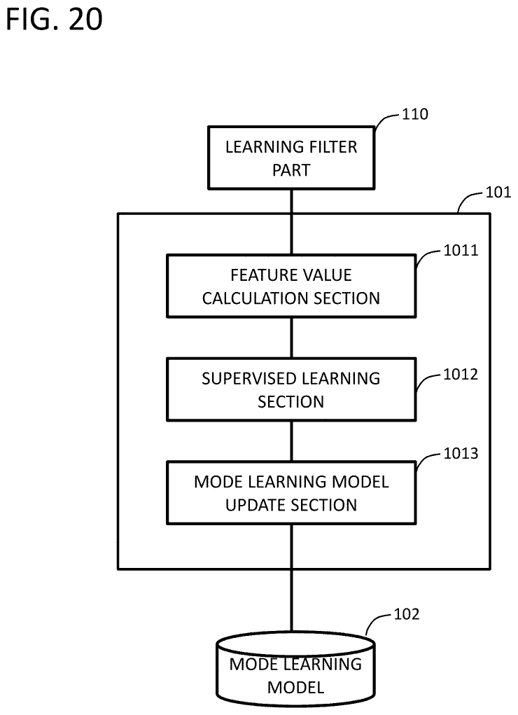

FIG. 20 is a diagram illustrating a function-block-based configuration example of the mode learning part 101 of the mode determination apparatus 10 according to the first example embodiment. Referring to FIG. 20, the mode learning part 101 comprises a feature value calculation section 1011, a supervised learning section 1012, and a mode learning model update section 1013.

The feature value calculation section 1011 calculates packet feature values from a packet sequence supplied by the learning filter part 110 in the learning phase. The packet feature values may be statistics on the packet size and packet arrival interval as described above.

The supervised learning section 1012 learns the feature values calculated by the feature value calculation section 1011 and information that a certain packet represents Mode so-and-so (the training data DB 112), using supervised learning. The mode learning model update section 1013 updates the mode learning model 102 based on the learning results.

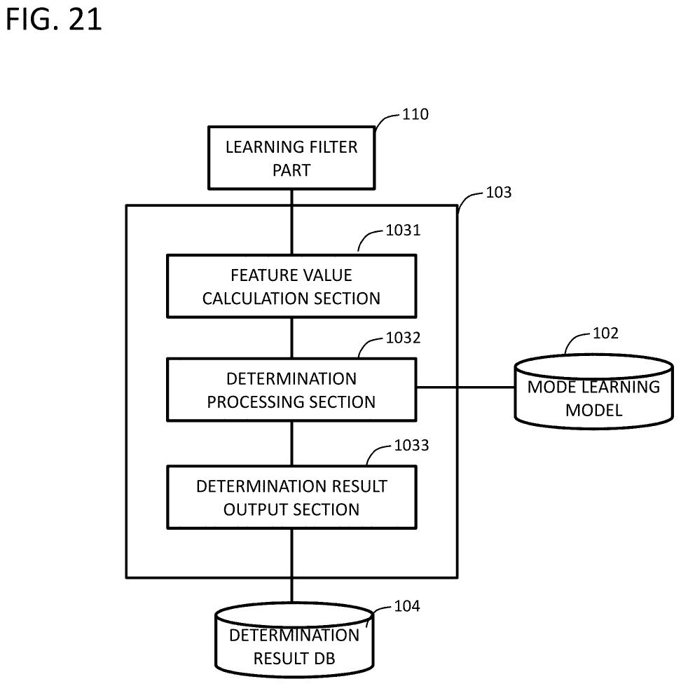

FIG. 21 is a diagram illustrating a function-block-based configuration example of the mode determination part 103 of the mode determination apparatus 10 according to the first example embodiment. Referring to FIG. 21, the mode determination part 103 includes a feature value calculation section 1031, a determination processing section 1032, and a determination result output section 1033.

The feature value calculation section 1031 calculates packet feature values of a packet sequence supplied by the learning filter part 110 in the determination phase. The packet feature values are the same as those used in the learning phase. The determination processing section 1032 determines to which mode the packets belong using the feature values calculated by the feature value calculation section 1031 and the mode learning model 102. The determination result output section 1033 outputs the determination results to the determination result DB 104. The determination result output section 1033 may output and display the determination results on a display apparatus not illustrated in the drawing.

### Example Embodiment 2: Mode Determination Apparatus

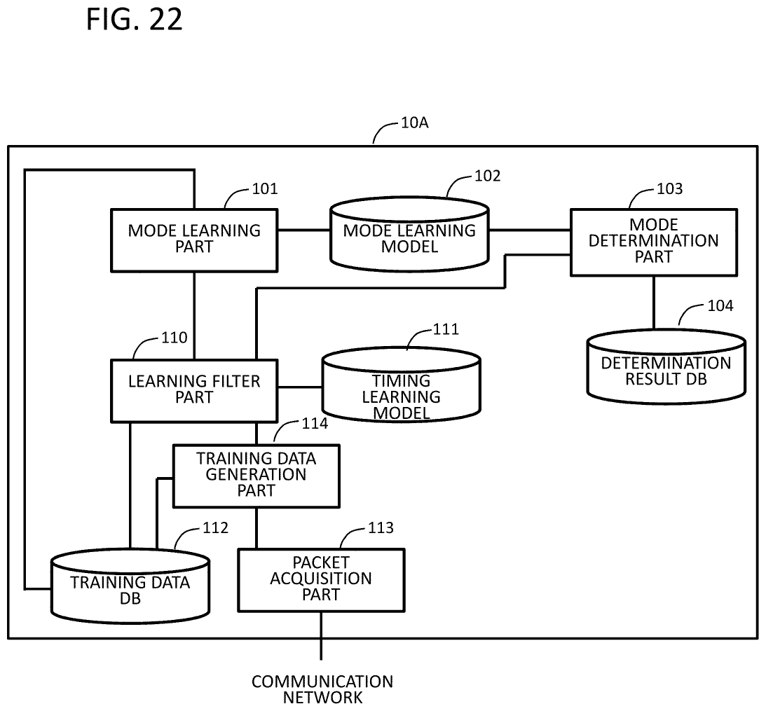

FIG. 22 is a diagram illustrating the configuration of a mode determination apparatus 10A according to a second example embodiment. Referring to FIG. 22, the mode determination apparatus 10A further includes a training data generation part 114 in addition to the configuration of the mode determination apparatus 10 illustrated in FIG. 11. The training data generation part 114 receives a packet sequence (for instance, packet sequence of traffic data for learning) acquired by the packet acquisition part 113, determines to which mode the packet sequence belongs, by using, for instance, DPI (Deep Packet Inspection), and updates the training data (correct modes) DB 112. An IP (Internet Protocol) packet has a plurality of headers (for instance, a leading (first) IP header, a second header (header of TCP or UDP (User Datagram Protocol) arranged in an upper layer of an IP layer), etc.). Shallow packet inspection (called stateful packet inspection, not deep) inspecting the second header may be used. Such a configuration may be also adopted in which all of layers 2 to 7 of the OSI Reference Model are inspected. Not only the header of the packet or the data structure of the protocol but also the payload may be inspected.

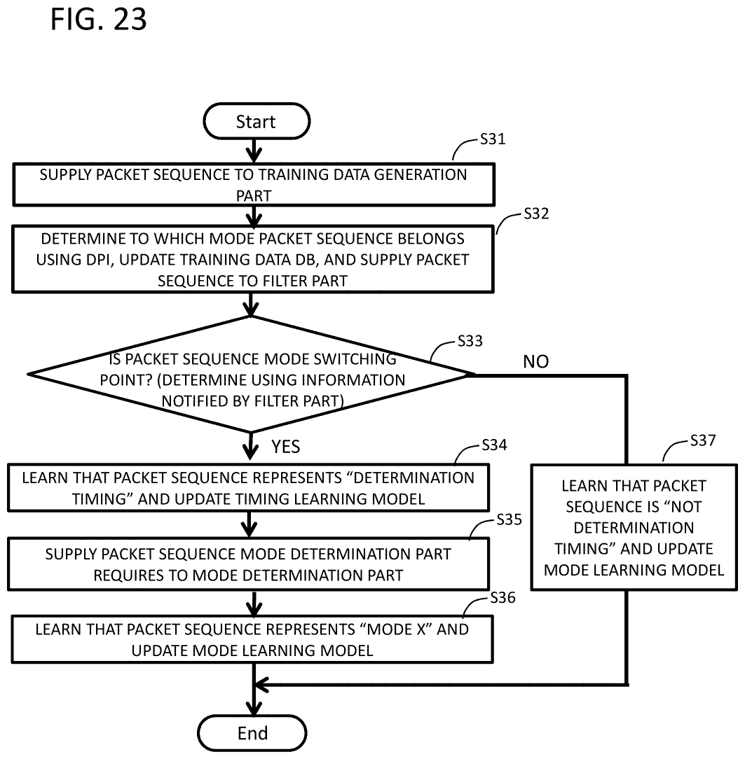

FIG. 23 is a flowchart illustrating the operation of the second example embodiment. Step S31 is a process by the packet acquisition part 113. Step S32 is a process by the training data generation part 114. Steps S33, S34, and S37 are processes by the learning filter part 110. Step S36 is a process by the mode determination part 103. The packet acquisition part 113 acquires a packet sequence and supplies it to the training data generation part 114 (S31).

The training data generation part 114 determines, to which mode the packet sequence supplied by the packet acquisition part 113 belongs, using, for instance, DPI, and updates the training data (for instance correct modes) DB 112. The training data generation part 114 supplies the packet sequence to the learning filter part 110.

The learning filter part 110 receives the packet sequence supplied by the training data generation part 114 and determines whether or not the packet sequence represents a mode switching point using the training data (correct modes) of the training data DB 112 created and updated by the training data generation part 114 (S33).

The learning filter part 110 calculates feature values (for instance statistics on the packet size and packet arrival interval) of a packet sequence extracted from the packet sequence which is supplied by the training data generation part 114 as in the first example embodiment. The learning filter part 110 learns the calculated feature values and that “the current packets represent a mode switching timing”, using supervised learning (S34).

The learning filter part 110 supplies the packet sequence representing a mode switching point to the mode learning part 101 (S35).

The mode learning part 101 learns that the packet sequence represents Mode so-and-so (“Mode X” in FIG. 23) and updates the mode learning model 102 (S36).

When determining that the packet sequence does not represent a switching point as a result of the determination in the step S33, the learning filter part 110 learns that the packet sequence “is not a determination timing” and updates the timing learning model (S37). Since the operation in the determination phase according to the second example embodiment is the same as that in the first example embodiment described with reference to FIG. 17, the explanation will be omitted.

According to the second example embodiment, training data (correct modes) are dynamically generated for a packet sequence from traffic flowing through a communication network, by using, for instance, DPI in the learning phase. As the traffic used to generate the training data (correct modes), actual traffic (such as traffic between a terminal and a server) flowing through a communication network can be used. According to the second example embodiment, it is made possible to generate training data reflecting traffic characteristic such as network load.

### Example Embodiment 3: Mode Determination Apparatus

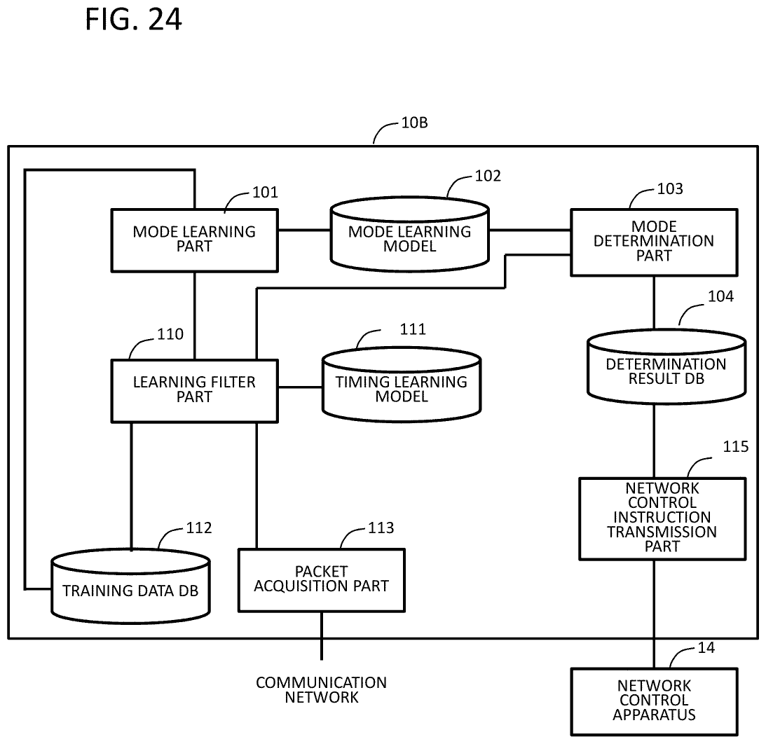

FIG. 24 is a diagram illustrating the configuration of a mode determination apparatus 10B according to a third example embodiment. Referring to FIG. 24, the mode determination apparatus 10B includes a network control instruction transmission part 115 in addition to the configuration of the mode determination apparatus 10 illustrated in FIG. 11. The network control instruction transmission part 115 transmits an instruction for a network control apparatus 14, based on mode determination results, so that, when a mode change has occurred, QoS and QoE requirements are met after the mode change. The network control apparatus 14 may be a base station or access point for a wireless access network. Alternatively, the network control apparatus 14 may be a node apparatus in a core network or a server connected to the communication network 13.

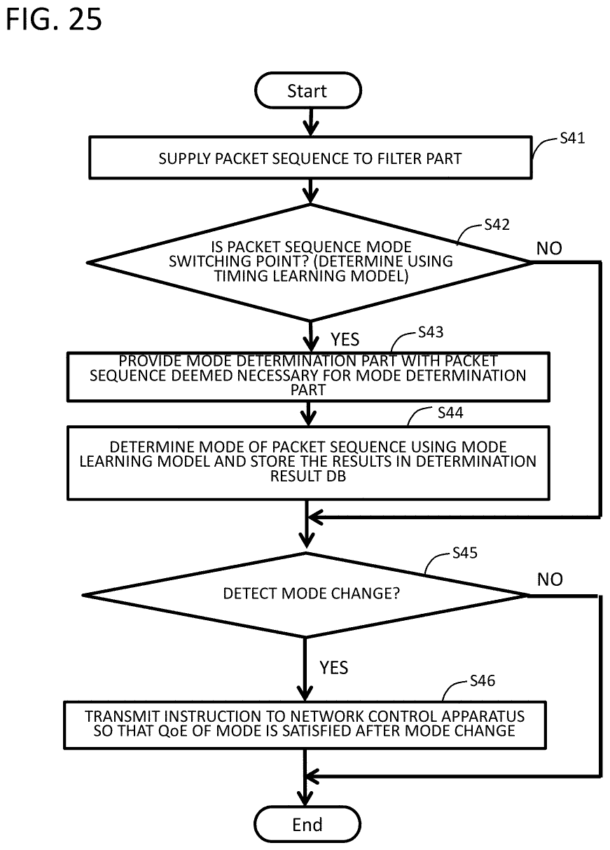

FIG. 25 is a flowchart illustrating the operation of the third example embodiment. In FIG. 25, since steps S41 to S44 are the same as the steps S21 to S24 in the determination phase of FIG. 17, the explanation will be omitted.

The network control instruction transmission part 115 receives a result of determination by the mode determination part 103, and when a mode change has occurred (Yes in S45), the network control instruction transmission part 115 transmits an instruction (control signal) to the network control apparatus 14 (S46) so that the QoE (and/or QoS) requirements for the mode after the change is met.

The network control instruction transmission part 115 may transmit to a base station (eNodeB) or wireless access point an instruction (control signal) controlling the number of resource blocks (RBs) allocated to a user terminal when controlling a bandwidth to meet the QoS or QoE requirements for the mode after the mode change. Alternatively, it may be configured to transmit a control signal scaling up/scaling out the performance of an application (VNF: Virtual Network Function) on a virtual machine (VM) realizing functions of a core network node using server virtualization to a management system (NFV (Network Function Virtualization) Management and Orchestration) of a virtual network constituting the network control apparatus 14. Alternatively, the mode determination apparatus 10B may be configured to be connected to, for instance, a network node of a core network. For instance, the mode determination apparatus 10B may work with an online charging system (OCS) in an EPC (Evolved Core network) and connect to a policy and charging rule function (PCRF) that manages and determines communication policy such as communication speed (bandwidth) according to the communication balance.

According to the present embodiment, it becomes possible to perform control such as allocation of communication bandwidths corresponding to the QoS or QoE after a mode switch.

### Example Embodiment 4: Mode Determination Apparatus

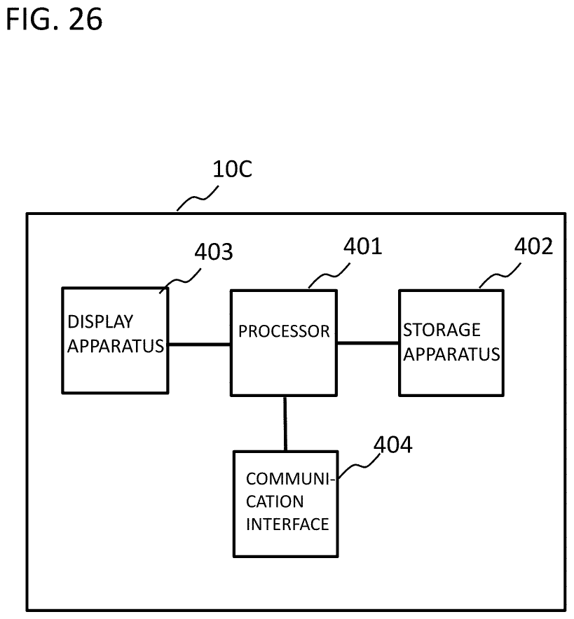

FIG. 26 is a diagram illustrating the configuration of a mode determination apparatus 10C according to a fourth example embodiment. The mode determination apparatus 10C is implemented by a computer apparatus. Referring to FIG. 26, the computer apparatus constituting the mode determination apparatus 10C includes a processor 401, a storage apparatus 402, a display apparatus 403, and a communication interface 404 such as a network interface card. The storage apparatus 402 stores a program executed by the processor 401. The processor 401 implements functions of each of the first to the third example embodiments by executing the program stored in the storage apparatus 402. It is noted that he storage apparatus 402 may store the timing learning model 111, the mode learning model 102, the determination result DB 104, and the training data DB 112 illustrated in FIG. 11.

### <Another Example Embodiment of the Network System>

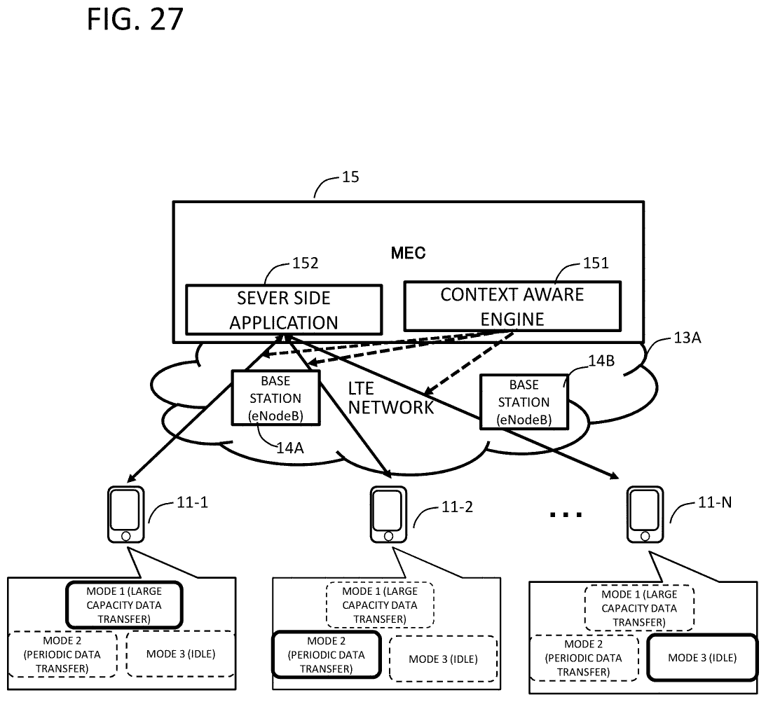

FIG. 27 is a diagram illustrating a system configuration of another example embodiment of the network system. In FIG. 27, a mobile edge computing (MEC) 15 is arranged in an LTE (Long Term Evolution) network (LTE access network) 13A that provides mobile communication services to terminals (User Equipment: UE) 11-1 to 11-N (N is an integer of 2 or more). By placing some of data processing functions in the mobile network, instead of on a cloud, using the mobile edge computing (MEC) 15, a communication distance is reduced to increase data processing speed. An application on a server (for instance, an application server), to which terminals 11-1 to 11-N normally are communicatively connected via an LTE network 13A, is arranged as a server side application 152 in the mobile edge computing (MEC) 15.

A context aware engine 151 included in the mobile edge computing (MEC) 15 calculates conditions (demands) to meet QoS or QoE requirements according to an operation mode of an application and transmits parameters (wireless parameters) to satisfy the QoE requirements to, for instance, base stations (eNodeB) 14A and 14B. It is noted that in FIG. 27 the base stations (eNodeB) 14A and 14B are illustrated for the sake of simplicity and the number of base stations is, as a matter of course, not limited to two. In FIG. 27, by connecting the mode determination apparatus 10 (10A, 10B, and 10C) according to one of the first to the fourth example embodiments described above to the context aware engine 151 in the MEC 15 or providing the mode determination apparatus in the MEC 15, it becomes possible to perform appropriate network control and network resource allocation in correspondence with QoS or QoE requirements of an application (network performance, traffic characteristics/status, etc., required by the application service). In the example of FIG. 27, as a result of real-time mode determination by the mode determination apparatus 10 (10A, 10B, and 10C), it is determined that at this moment, the terminal 11-1 is in Mode 1 (high volume data transfer), the terminal 11-2 is in Mode 2 (periodic data transfer), and the terminal 11-N is in Mode 3 (idle).

The mode determination apparatus 10 may control a server in the MEC 15 via the network control apparatus 14 in FIG. 24. Alternatively, for an application running on a virtual machine (VM) on a server constituting the MEC 15, the mode determination apparatus 10 may control to add or reduce the number of virtual CPUs (Central Processing Units) allocated to the virtual machine and capacity of virtual memory(alternatively, increase or decrease performance of virtual CPU and virtual memory), via the network control apparatus 14 in FIG. 24.

In the example embodiments above, a Naive Bayes classifier or a neural network may be used as a technique for learning a timing learning model and a mode learning model, in addition to a classifier such as a random forest. As a window for learning/determination, the following may be used.

1) Packet sequence immediately before a switching timing
2) Packet sequence immediately after a switching timing,
3) Packet sequences before and after a switching timing, or
A majority decision among the above 1) to 3) may be used.

Further, each disclosure of Patent Literatures 1 to 3 and Non-Patent Literature 1 cited above is incorporated herein in its entirety by reference thereto. It is to be noted that it is possible to modify or adjust the example embodiments or examples within the whole disclosure of the present invention (including the Claims) and based on the basic technical concept thereof. Further, it is possible to variously combine or select a wide variety of the disclosed elements (including the individual elements of the individual claims, the individual elements of the individual examples and the individual elements of the individual figures) within the scope of the Claims of the present invention. That is, it is self-explanatory that the present invention includes any types of variations and modifications to be done by a skilled person according to the whole disclosure including the Claims, and the technical concept of the present invention.

The example embodiments above can be described as the following supplementary notes (but not limited thereto).

### (Supplementary Note 1)

A mode determination apparatus comprising:
a filter part that receives traffic data for learning and learns timing at which mode switching in the traffic data occurs, using training data; and
a mode learning part that generates a mode learning model for mode determination based on the traffic data for learning and the training data that correspond to the timing of mode switching, the mode determination apparatus determining a mode of actual traffic data, using the mode learning model.

### (Supplementary Note 2)

The mode determination apparatus according to Supplementary Note 1, comprising the mode determination part that determines, by using the mode learning model, a mode of the actual traffic data corresponding to the timing learned by the filter part.

### (Supplementary Note 3)

The mode determination apparatus according to Supplementary Note 2, wherein the filter part receives the actual traffic data, determines timing corresponding to mode switching, based on the learned timing, and supplies the actual traffic data of the timing corresponding to the mode switching to the mode determination part in a determination phase.

### (Supplementary Note 4)

The mode determination apparatus according to any one of Supplementary Notes 1 to 3, further comprising a training data generation part that analyzes packets constituting the traffic data for learning, determines to which mode the packets belong, and creates the training data.

### (Supplementary Note 5)

The mode determination apparatus according to any one of Supplementary Notes 1 to 4, further comprising a control instruction generation part that generates a control instruction signal for an apparatus that controls a network based on a result of mode determination by the mode determination part.

### (Supplementary Note 6)

The mode determination apparatus according to any one of Supplementary Notes 1 to 5, comprising a packet acquisition part that captures packets flowing through a network.

### (Supplementary Note 7)

The mode determination apparatus according to Supplementary Note 6, wherein the filter part in a learning phase, receives packets of traffic for learning acquired by the packet acquisition part, determines whether or not the packets correspond to a mode switching point, using the training data, calculates feature values of a packet sequence of a window of a predetermined length including the packets, learns the feature values and that the packets do or don't correspond to a mode switching timing, using supervised learning to update a timing learning model, and supplies the packet sequence including the packets to the mode learning part when the packets represent a mode switching timing.

### (Supplementary Note 8)

The mode determination apparatus according to Supplementary Note 7, wherein the filter part in a determination phase, receives packets of actual traffic acquired by the packet acquisition part, calculates feature values of a packet sequence of the window of the predetermined length including the packets of the actual traffic, determines whether or not the packets represent a mode switching timing using the feature values and the timing learning model, and supplies the packet sequence including the packets to the mode determination part when the packets represent a mode switching timing.

### (Supplementary Note 9)

The mode determination apparatus according to Supplementary Note 7 or 8, wherein the mode learning part calculates feature values of the packet sequence including the packets supplied by the filter part, learns the feature values and a mode to which the packets belong, using supervised learning to update a mode learning model.

### (Supplementary Note 10)

The mode determination apparatus according to Supplementary Note 9, wherein the mode determination part calculates feature values of the packet sequence including the packets supplied by the filter part and determines to which mode the packets belong using the feature values and the mode learning model.

### (Supplementary Note 11)

A mode determination method using a computer, comprising:
a filtering process that includes
   receiving traffic data for learning and performing learning of timing at which mode switching in the traffic data occurs, using training data;
a model learning process that includes
   generating a mode learning model used for mode determination, based on the traffic data for learning and the training data that correspond to the timing of mode switching; and
a mode determination process that includes
   determining a mode of actual traffic data, using the mode learning model.

### (Supplementary Note 12)

The mode determination method according to Supplementary Note 11, wherein the mode determination process includes
determining a mode of the actual traffic data corresponding to the timing learned in the filtering process using the mode learning model.

### (Supplementary Note 13)

The mode determination method according to Supplementary Note 12, wherein

the filtering process in a determination phase comprises:
receiving the actual traffic data;
determining timing corresponding to mode switching, based on the learned timing; and
supplying the actual traffic data of the timing corresponding to the mode switching to the mode determination process.

### (Supplementary Note 14)

The mode determination method according to any one of Supplementary Notes 11 to 13, further comprising
a training data creation process including:
analyzing packets constituting the traffic data for learning;
determining to which mode the packets belong; and
creating the training data.

### (Supplementary Note 15)

The mode determination method according to any one of Supplementary Notes 11 to 14, further comprising
a control instruction generation process of generating a control instruction signal for an apparatus that controls a network based on a determination result in the mode determination process.

### (Supplementary Note 16)

The mode determination method according to any one of Supplementary Notes 11 to 15, comprising
a packet acquisition process of capturing packets flowing through a network.

### (Supplementary Note 17)

The mode determination method according to Supplementary Note 16, wherein the filtering process in a learning phase comprises:
receiving packets of traffic for learning acquired in the packet acquisition process;
determining whether the packets correspond to a mode switching point using the training data;
calculating feature values of a packet sequence of a window of a predetermined length including the packets;
learning the feature values and that the packets do or don't correspond to a mode switching timing, using supervised learning to update a timing learning model; and
supplying the packet sequence including the packets to the mode learning process, when the packets correspond to the mode switching timing.

### (Supplementary Note 18)

The mode determination method according to Supplementary Note 17, wherein the filtering process in a determination phase comprises:
receiving packets of actual traffic acquired in the packet acquisition process;
calculating feature values of a packet sequence of the window of the predetermined length including the packets of the actual traffic;
determining whether or not the packets represent a mode switching timing, using the feature values and the timing learning model; and
supplying the packet sequence including the packets to the mode determination process, when the packets represent a mode switching timing.

### (Supplementary Note 19)

The mode determination method according to Supplementary Note 17 or 18, wherein the mode learning process comprises
calculating feature values of the packet sequence including the packets supplied in the filtering process; and
learning the feature values and a mode to which the packets belong in supervised learning to update a mode learning model.

### (Supplementary Note 20)

The mode determination method according to Supplementary Note 19, wherein the mode determination process comprises
calculating feature values of the packet sequence including the packets supplied in the filtering process; and
determining to which mode the packets belong using the feature values and the mode learning model.

### (Supplementary Note 21)

A program causing a computer to execute:

a filtering process of receiving traffic data for learning and performing learning of timing at which mode switching in the traffic data occurs using training data;
a model learning process of generating a mode learning model for mode determination based on the traffic data for learning and the training data that correspond to the timing of mode switching; and
a mode determination process of determining a mode of actual traffic data, using the mode learning model.

### (Supplementary Note 22)

The program according to Supplementary Note 21, wherein the mode determination process determines a mode of the actual traffic data corresponding to the timing learned in the filtering process using the mode learning model.

### (Supplementary Note 23)

The program according to Supplementary Note 22, wherein the filtering process in a determination phase receives the actual traffic data, determines timing corresponding to mode switching, based on the learned timing, and supplies the actual traffic data of the timing corresponding to the mode switching to the mode determination process.

### (Supplementary Note 24)

The program according to any one of Supplementary Notes 21 to 23, causing the computer to further execute a training data creation process of analyzing packets constituting the traffic data for learning, determining to which mode the packets belong, and creating the training data.

### (Supplementary Note 25)

The program according to any one of Supplementary Notes 21 to 24, causing the computer to further execute a control instruction generation process of generating a control instruction signal for an apparatus that controls a network based on a determination result in the mode determination process.

### (Supplementary Note 26)

The program according to any one of Supplementary Notes 21 to 25, causing the computer to further execute a packet acquisition process of capturing a packet flowing through a network.

### (Supplementary Note 27)

The program according to Supplementary Note 26, wherein the filtering process in a learning phase, receives packets of traffic for learning acquired in the packet acquisition process, determines whether or not the packets correspond to a mode switching point, using the training data, calculates feature values of a packet sequence of a window of a predetermined length including the packets, learns the feature values and that the packets do or don't correspond to a mode switching timing, using supervised learning to update a timing learning model, and supplies the packet sequence including the packets to the mode learning process when the packets represent a mode switching timing.

### (Supplementary Note 28)

The program according to Supplementary Note 27, wherein the filtering process in a determination phase, receives packets of actual traffic acquired in the packet acquisition process, calculates feature values of a packet sequence of the window of the predetermined length including the packets of the actual traffic, determines whether or not the packets represent a mode switching timing using the feature values and the timing learning model, and supplies the packet sequence including the packets to the mode determination process, when the packets correspond to the mode switching timing.

### (Supplementary Note 29)

The program according to Supplementary Note 27 or 28, wherein the mode learning process calculates feature values of the packet sequence including the packets supplied in the filtering process, learns the feature values and a mode to which the packets belong, using supervised learning to update a mode learning model.

### (Supplementary Note 30)

The program according to Supplementary Note 29, wherein the mode determination process calculates feature values of the packet sequence including the packets supplied in the filtering process and determines to which mode the packets belong using the feature values and the mode learning model.

### (Supplementary Note 31)

A network system comprising:

a mode determination apparatus that includes a filter that receives traffic data for learning and performs learning of timing at which mode switching in the traffic data occurs, using training data and a mode learning part generating a mode learning model for mode determination based on the traffic data for learning and the training data that correspond to the timing of mode switching, wherein the mode determination apparatus determines a mode of traffic data using the mode learning model; and
a network control apparatus that controls network traffic, based on a result of mode determination by the mode determination apparatus.

### (Supplementary Note 32)

The network system according to Supplementary Note 31, wherein the mode determination apparatus comprises a mode determination part that determines, by using the mode learning model, a mode of the actual traffic data corresponding to the timing learned by the filter part.

### (Supplementary Note 33)

The network system according to Supplementary Note 32, wherein the filter part in the mode determination apparatus in a determination phase receives the actual traffic data, determines timing corresponding to mode switching, based on the learned timing, and supplies the actual traffic data of the timing corresponding to the mode switching to the mode determination part.

### (Supplementary Note 34)

A mobile edge computing (MEC) apparatus comprising the mode determination apparatus according to any one of Supplementary Notes 1 to 10.

### (Supplementary Note 35)

A context aware engine apparatus comprising the mode determination apparatus according to any one of Supplementary Notes 1 to 10.

1. A mode determination apparatus comprising:
a processor; and
a memory storing program instructions executable by the processor,
wherein the processor is configured to execute:
a filter process that receives traffic data for learning to learn, by using training data, a timing of mode switching in the traffic data for learning;
a mode learning process that generates a mode learning model to be used for mode determination, based on the traffic data for learning and the training data that correspond to the timing of mode switching; and
a mode determination process that determines, by using the mode learning model, a mode of actual traffic data received.

2. The mode determination apparatus according to claim 1, wherein
the processor is configured to execute the mode determination process that determines, by using the mode learning model, a mode for the actual traffic data that corresponds to the timing learned by the filter process.

3. The mode determination apparatus according to claim 1, wherein the processor is configured to execute the filter process that in a determination phase receives the actual traffic data, determines timing corresponding to mode switching, based on the timing learned, and supplies, to the mode determination process, the actual traffic data of the timing corresponding to the mode switching.

4. The mode determination apparatus according to claim 1, wherein the processor is further configured to execute
a training data generation process that analyzes packets constituting the traffic data for learning, determines to which mode the packet belong, and creates the training data.

5. The mode determination apparatus according to claim 1, wherein the processor is further configured to execute
a control instruction generation process that generates a control instruction signal for an apparatus that controls a network, based on a result of mode determination by the mode determination process.

6. The mode determination apparatus according to claim 1, wherein the processor is configured to execute
a packet acquisition process that captures, via the network interface, packets flowing through a network.

7. The mode determination apparatus according to claim 6, wherein the processor is configured to execute the filter process that in a learning phase, receives packets of traffic for learning acquired by the packet acquisition process,
determines whether or not the packets correspond to a mode switching point, using the training data,
calculates feature values of a packet sequence of a window of a predetermined length including the packets,
learns the feature values and that the packets do or don't correspond to a mode switching timing, using supervised learning to update a timing learning model, and
supplies the packet sequence including the packets to the mode learning process, when the packets correspond to the mode switching timing.

8. The mode determination apparatus according to claim 7, wherein the processor is configured to execute the filter process that in a determination phase, receives packets of actual traffic acquired by the packet acquisition process,
calculates feature values of a packet sequence of the window of the predetermined length including the packets of the actual traffic,
determines whether or not the packets represent a mode switching timing, using the feature values and the timing learning model, and
supplies the packet sequence including the packets to the mode determination process, when the packets correspond to the mode switching timing.

9. The mode determination apparatus according to claim 7, wherein the processor is configured to execute the mode learning process that calculates feature values of the packet sequence including the packets supplied by the filter process, and
learns the feature values and a mode to which the packets belong, using supervised learning to update a mode learning model.

10. The mode determination apparatus according to claim 9, wherein the processor is configured to execute the mode determination process that calculates feature values of the packet sequence including the packets supplied by the filter process, and
determines to which mode the packets belong, using the feature values and the mode learning model.

11. A mode determination method using a computer, comprising:
a filtering process that includes
receiving traffic data for learning and performing learning of timing at which mode switching in the traffic data occurs, using training data;
a model learning process that includes
generating a mode learning model used for mode determination, based on the traffic data for learning and the training data that correspond to the timing of mode switching; and
a mode determination process that includes
determining a mode of actual traffic data received, using the mode learning model.

12. The mode determination method according to claim 11, wherein the mode determination process includes
determining a mode of the actual traffic data corresponding to the timing learned in the filtering process, using the mode learning model.

13. The mode determination method according to claim 12, wherein the filtering process in a determination phase comprises:
receiving the actual traffic data;
determining timing corresponding to mode switching, based on the learned timing; and
supplying the actual traffic data of the timing corresponding to the mode switching to the mode determination process.

14. The mode determination method according to claim 11, further comprising
a training data creation process including:
analyzing packets constituting the traffic data for learning;
determining to which mode the packets belong; and
creating the training data.

15. (canceled)

16. The mode determination method according to claim 11, comprising
a packet acquisition process of capturing packets flowing through a network.

17. The mode determination method according to claim 16, wherein the filtering process in a learning phase comprises:
receiving packets of traffic for learning acquired in the packet acquisition process;
determining whether the packets correspond to a mode switching point using the training data;
calculating feature values of a packet sequence of a window of a predetermined length including the packets;
learning the feature values and that the packets do or don't correspond to a mode switching timing, using supervised learning to update a timing learning model; and
supplying the packet sequence including the packets to the mode learning process, when the packets correspond to the mode switching timing.

18. The mode determination method according to claim 17, wherein the filtering process in a determination phase comprises:
receiving packets of actual traffic acquired in the packet acquisition process;
calculating feature values of a packet sequence of the window of the predetermined length including the packets of the actual traffic;
determining whether or not the packets represent a mode switching timing, using the feature values and the timing learning model; and
supplying the packet sequence including the packets to the mode determination process, when the packets represent a mode switching timing.

19. The mode determination method according to claim 17, wherein the mode learning process comprises
calculating feature values of the packet sequence including the packets supplied in the filtering process; and
learning the feature values and a mode to which the packets belong in supervised learning to update a mode learning model.

20. The mode determination method according to claim 19, wherein the mode determination process comprises
calculating feature values of the packet sequence including the packets supplied in the filtering process; and
determining to which mode the packets belong using the feature values and the mode learning model.

21. A non-transitory computer readable recording medium storing therein a program causing a computer to execute processing comprising:
receiving traffic data for learning and performing learning of timing at which mode switching in the traffic data occurs using training data;
generating a mode learning model for mode determination, based on the traffic data for learning and the training data that correspond to the timing of mode switching; and
determining a mode of actual traffic data received, using the mode learning model.

22-35. (canceled)
